(19) United States
(12) Patent Application Publication
(10) Pub. No.: US 2013/0132269 A1
(43) Pub. Date: May 23, 2013

(54) METHOD AND SYSTEM FOR QUANTIFYING AND RATING DEFAULT RISK OF BUSINESS ENTERPRISES

(71) Applicant: The Dun and Bradstreet Corporation, Short Hills, NJ (US)

(72) Inventors: Isaac C. Abiola, New Providence, NJ (US); Paul Chin, Whippany, NJ (US); Jianging Ling, Brighton, MA (US); Soumia Lotfi, Bruxelles (BE); Joan Kelleher, Berndardsville, NJ (US); Mike Danitz, Chatham, NJ (US)

(73) Assignee: The Dun and Bradstreet Corporation, Short Hills, NJ (US)

(21) Appl. No.: 13/738,375

(22) Filed: Jan. 10, 2013

Related U.S. Application Data
(63) Continuation of application No. PCT/US2011/046525, filed on Aug. 4, 2011.
(60) Provisional application No. 61/371,538, filed on Aug. 6, 2010.

(51) Int. Cl. G06Q 40/02

(52) U.S. Cl. CPC G06Q 40/025
USPC 705/38

(57) ABSTRACT

A method for evaluating a risk of default for a business. The method includes categorizing commercial data into a plurality of commercial attributes, allocating each of the commercial attributes to at least one of a plurality of commercial modules, ranking each of the commercial attributes according to best-attributes for each one of the plurality of commercial modules, applying a logistic regression model to the best-attributes to yield a commercial score for each one of the plurality of commercial modules; and determining a commercial risk model score by combining all of the commercial scores for the plurality of commercial modules.

### BACKGROUND OF THE DISCLOSURE

1. Field of Disclosure

The present disclosure relates generally to a method and system for quantifying and rating default risk of business enterprises based upon on commercial data and consumer attribute data (i.e., individual information), rather than only on a portion of information, thus enhancing the ability to predict whether a business enterprise is at risk of default.

2. Description of Related Art

In conventional methods there is no classification of modeling attributes into different information groups or classes. As a result, when developing default risk models all potential predictor attributes are matched to the dependent variable. The problem with this particular approach is that there is a different degree of frequency of missing data points. Some of the attributes are more populated than the others.

The problem caused by the missing data is such that the final model used to quantify risk is dominated by a set of attributes coming from a particular information group alone even when other information groups may have been more relevant to that particular business.

The present inventors discovered that in the instance where a model is based on a trade attributes and financials, if millions of records used in model development have trade based attributes but only a few hundred have financial data, then the risk model will be dominated by trade attributes, while only one or two attributes may be coming from financials. Thus, the disadvantage of the convention modeling and scoring is that the trade attributes, according to the example above, will overwhelm the financial data because financial attributes are not present for many of the records. Based on this scenario the financial attributes will often come across as not being significant driver of risk.

That is, model results driven principally by trade based attributes may be appropriate for the smallest businesses but not for medium to large enterprises where the financial position of the business may be more important. The risk evaluation for the relatively larger business driven largely by trade may thus be erroneous.

The present disclosure overcomes the disadvantages and erroneous risk rating or score generated by the conventional model, by creating a business default risk (i.e., commercial credit score, that is based on all (not partial) information available, i.e., financial information, personal consumer information, short term trade information, long term trade credit information, long term payment behavior, firm-o-graphic and public record information, etc. The present disclosure uniquely quantifies the effect for default risk of the elements in each information group, and thereafter combines in an optimal manner the default risk assessment from each information group, thus providing an enhanced default risk or score.

The present disclosure also provides many additional advantages, which shall become apparent as described below.

### SUMMARY

It is an object of the present disclosure to provide a method for evaluating a business default risk, the method includes: categorizing all information maintained in an information database into selected information groups, quantifying the effect for default risk of the elements in each information group, and combining the default risk assessments from each information group, provided that in the event that the information database lack data for a particular information group, the business default risk is evaluated only on the information groups that the database the data on.

Preferably, the information group is at least one selected from the group consisting of: financial information, personal consumer information, short term trade information, long term trade credit information, long term payment behavior, firm-o-graphic and public record information.

Further, it is the object of the present disclosure to provide a method for evaluating a risk of default for a business. The method includes categorizing commercial data into a plurality of commercial attributes, allocating each of the commercial attributes to at least one of a plurality of commercial modules, ranking each of the commercial attributes according to best-attributes for each one of the plurality of commercial modules, applying a logistic regression model to the best-attributes to yield a commercial score for each one of the plurality of commercial modules; and determining a commercial risk model score by combining all of the commercial scores for the plurality of commercial modules.

Still further, it is another object of the present disclosure to provide another method for evaluating a risk of default for a business. This method includes receiving commercial data, the commercial data including firm-o-graphic and public record data, geo-risk data, industry risk data, and a current commercial credit score data. The method further includes quantifying effects for risk of default for each of the firm-o-graphic and public record data, geo-risk data, industry risk data, and a current commercial credit score data, yielding a plurality of commercial effects, combining the plurality of commercial effects, yielding a commercial risk of default score, determining a penalty score according to at least one penalty group selected from the groups consisting of: a business deterioration, a business uncertainty, and a high risk alert or information alert, and applying the penalty score to the commercial risk of default score, yielding a final default score.

In some embodiments, the above-discussed method further includes receiving consumer attribute data, the consumer attribute data is one selected from the group consisting of: a zip level consumer attribute based on a consumer risk score, and an individual level consumer attribute based on the commercial risk score. The method further includes quantifying a consumer effect for risk of default according to the consumer attribute data, and combining the commercial risk of default score and the consumer effect, yielding a blended risk of default score. In addition, when applying the penalty score, the method further includes applying the penalty score to the blended risk of default score, yielding the final default score.

In addition, the present disclosure provides a non-transitory storage medium that includes instructions for evaluating a risk of default for a business which are readable by a processor and cause the processor to categorize commercial data into a plurality of commercial attributes, allocate each of the commercial attributes to at least one of a plurality of commercial modules, rank each of the commercial attributes according to best-attributes for each one of the plurality of commercial modules, apply a logistic regression model to the best-attributes to yield a commercial score for each one of the plurality of commercial modules, and determine a commercial risk model score by combining all of the commercial scores for the plurality of commercial modules.

Still further, the present disclosure provides a system for evaluating a risk of default for a business. The system includes a processor, and a memory that contains instructions that are readable by the processor and cause the processor to categorize commercial data into a plurality of commercial attributes. The instructions further cause the processor to allocate each of the commercial attributes to at least one of a plurality of commercial modules, rank each of the commercial attributes according to best-attributes for each one of the plurality of commercial modules, apply a logistic regression model to the best-attributes to yield a commercial score for each one of the plurality of commercial modules, and determine a commercial risk model score by combining all of the commercial scores for the plurality of commercial modules.

Further objects, features and advantages of the present disclosure will be understood by reference to the following drawings and detailed description.

### BRIEF DESCRIPTION OF THE DRAWINGS

FIG. 1 is a block diagram of computer system used to perform the risk default assessment or score according to the present disclosure;

FIG. 2 is a schematic representation of the commercial credit score process of collecting all scores or attributes from commercial data and consumer data and processing according to the present disclosure to produce the enhanced commercial credit score according to the present disclosure;

FIG. 3 is a block diagram depicting the general methodology for quantifying and rating default risk of business enterprises according to the present disclosure;

FIG. 4 is a block diagram depicting the methodology when used with micro and small businesses with trades but no significant post model information;

FIG. 5 is a block diagram depicting the methodology when used with micro and small businesses with no trade history and no significant post model development information;

FIG. 6 is a block diagram depicting the methodology when used with large businesses with NRSO rating, D&B rating, financial statements and significant post model development information and no trade history;

FIG. 7 is a block diagram depicting the methodology when used with large businesses with D&B trades, D&B rating, financial statements and no significant post model development information and No NRSO; and

FIG. 8 is a block diagram depicting the methodology when used with large businesses with no NRSO rating, D&B rating, financial statements and significant post model development information.

A component or a feature that is common to more than one drawing is indicated with the same reference number in each of the drawings.

### DETAILED DESCRIPTION OF THE PREFERRED EMBODIMENT

The present disclosure evaluates a business default risk based on its obligations based on all information available. The method includes the following steps:
categorizing all information into different classes from at least one selected from the group consisting of: financial information, personal consumer information, short term trade information, long term trade credit information, long term payment behavior, firm-o-graphic and public record information, although a plurality of classes is more preferable;
quantifying the effect for default risk of the elements in each information group; and
combining the default risk assessments from each information group; provided, however, that in the event that the databases lack data in a particular information group the business risk is evaluated only on the information groups that the databases have collected data on.

The aforementioned method of evaluating a business default risk is that one is able to generate a valid, accurate and reliable default risk evaluation based on all information available to it.

As an example, when only financial information and trade information are available, the present disclosure will organize the information into two classes, i.e., financial information and trade information. The methodology then evaluates default risk based on all trade based attributes alone on all businesses that have non-missing trade data. Likewise, the system then evaluates default risk on businesses based on all businesses with financials only. This separate evaluation allows the present inventors to fully account for the impact of each information group. After assessing the impact of each information group/class, the system then combines in an optimal manner the default risk assessments from each information group/class. This results in the following three scenarios:
1. If one needs to evaluate a business that has both financial and trade information, then they can use the combined default risk to evaluate the particular business. The result will then take into account fully all the information the database has on the business.
2. If there is no financial information available for the business being evaluated, then the estimate obtained from the trade based default risk algorithm will be used to quantify the risk inherent in the business. This evaluation that does not factor in financials is still accurate, reliable, and optimal for the business given the limited amount of information that the database has on it.
3. And when only financial information is available, then the business will be evaluated on the basis of the financial driven default risk algorithm only. Again, the evaluation is more accurate, reliable and optimal for the business especially where it is a large business where financials are more relevant to default risk.

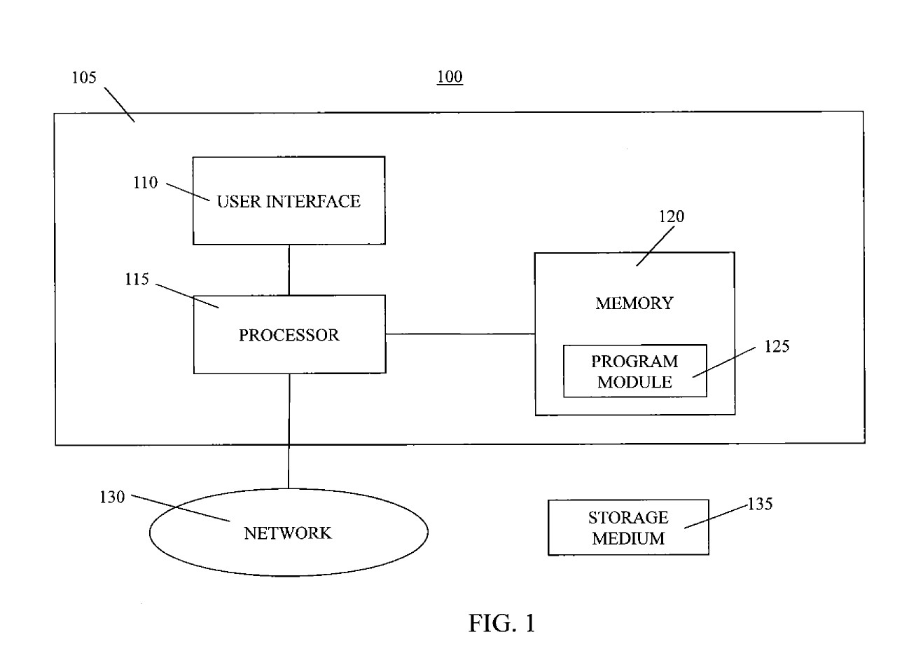

The present disclosure can best be described by referring to the attached drawings, wherein FIG. 1 is a block diagram of a system 100, for employment of the present invention. System 100 includes a computer 105 coupled to a network 130, e.g., the Internet.

Computer 105 includes a user interface 110, a processor 115, and a memory 120. Computer 105 may be implemented on a general-purpose microcomputer. Although computer 105 is represented herein as a standalone device, it is not limited to such, but instead can be coupled to other devices (not shown) via network 130.

Processor 115 is configured of logic circuitry that responds to and executes instructions.

Memory 120 stores data and instructions for controlling the operation of processor 115. Memory 120 may be implemented in a random access memory (RAM), a hard drive, a read only memory (ROM), or a combination thereof. One of the components of memory 120 is a program module 125.

Program module 125 contains instructions for controlling processor 115 to execute the methods described herein. For example, as a result of execution of program module 125, processor 115 carries out the following steps:
(1) categorizing all information into different classes from at least one selected from the group consisting of: financial information, personal consumer information, short term trade information, long term trade credit information, long term payment behavior, firm-o-graphic and public record information, although a plurality of classes is more preferable;
(2) quantifying the effect for default risk of the elements in each information group; and
(3) combining the default risk assessments from each information group; provided, however, that in the event that the databases lack data in a particular information group the business risk is evaluated only on the information groups that the databases have collected data on.

The term “module” is used herein to denote a functional operation that may be embodied either as a stand-alone component or as an integrated configuration of a plurality of sub-ordinate components. Thus, program module 125 may be implemented as a single module or as a plurality of modules that operate in cooperation with one another. Moreover, although program module 125 is described herein as being installed in memory 120, and therefore being implemented in software, it could be implemented in any of hardware (e.g., electronic circuitry), firmware, software, or a combination thereof.

User interface 110 includes an input device, such as a keyboard or speech recognition subsystem, for enabling a user to communicate information and command selections to processor 115. User interface 110 also includes an output device such as a display or a printer. A cursor control such as a mouse, track-ball, or joy stick, allows the user to manipulate a cursor on the display for communicating additional information and command selections to processor 115.

Processor 115 outputs, to user interface 110, a result of an execution of the methods described herein. Alternatively, processor 115 could direct the output to a remote device (not shown) via network 130.

While program module 125 is indicated as already loaded into memory 120, it may be configured on a storage medium 135 for subsequent loading into memory 120. Storage medium 135 can be any conventional storage medium that stores program module 125 thereon in tangible form. Examples of storage medium 135 include a floppy disk, a compact disk, a magnetic tape, a read only memory, an optical storage media, universal serial bus (USB) flash drive, a digital versatile disc, or a zip drive. Alternatively, storage medium 135 can be a random access memory, or other type of electronic storage, located on a remote storage system and coupled to computer 105 via network 130.

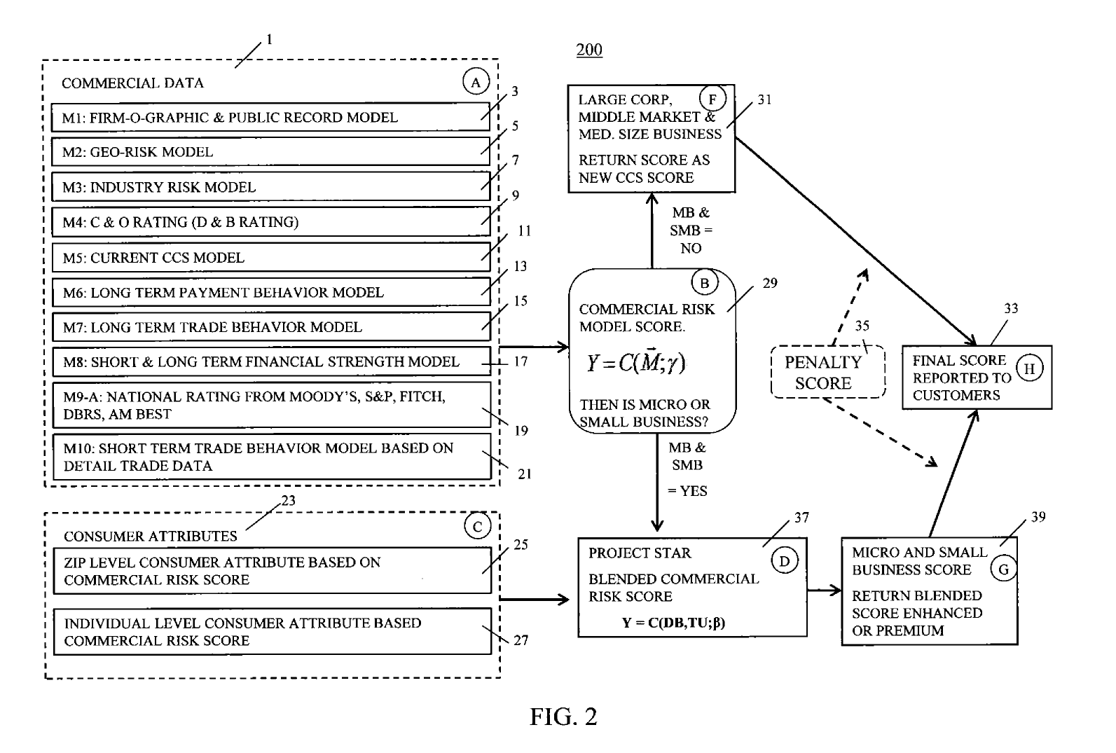

The description above using only financial and trade information groups can also be generalized into N-information based groups. For example, FIG. 2 is a block diagram 200 that depicts the methodology of the present disclosure.

FIG. 2 illustrates a system 200 for quantifying and rating default risk of a business enterprise according to the present disclosure.

System 200 includes a database A having commercial data 1, a database C having consumer attributes 23 and a set of decision blocks, i.e., B, D, F and G, which process data from database A and database C to yield a Final Score Reported to Customers 33 in block H.

For example, commercial data 1 of database A provides a set of scores according to modules, i.e., M1-M10, to Block B: commercial risk model score.

Block B receives the set of scores and determines a commercial risk model score 29. System 200 then determines if the business is a micro-business (MB) or a small business (SMB). If the business is not a MB or SMB, system 200 transmits the commercial risk model score 29, calculated in block B, to block F or large corp, middle market & med. size business 31.

Block F receives commercial risk model score 29 and assigns as a “new ccs score”. System 200 then applies a penalty score 35 to the new ccs score, if appropriate, and transmits the new ccs score to block H: final score reported to customers 33.

If the business is a MB or SMB, system 200 transmits the commercial risk model score 29, calculated in block B, to block D or project star 37.

Block D receives the commercial risk model score 29 and also receives consumer attributes 23 from block C. Block D combines, or blends, both the commercial risk model score 29 and the consumer attributes 23, yielding a blended commercial risk score 37. The blended commercial risk score 37 is calculated from commercial data 1 and the consumer attributes 23 (typically a commercial score). The consumer bureau attributes can be either at the ZIP Code level or the individual principle level.

In Block G, the membership of a DUNS in Micro or Small Business is identified. Given the size membership, e.g., Micro, the scores calculated from Block D are sorted in descending order. The top scoring 1% of the businesses have the rank of 100 among the Micro businesses. The next top scoring 1% have a rank of 99 and so on until the bottom scoring group is reached. Then a rank is assigned to each business in a particular size range.

From Block G, the sorted scores are dispatched to Block H final score 33 to report to customers. Prior to Block H, however, a penalty score 35 can be applied according to various business risks not previously accounted for. These risks are discussed in greater detail below.

Block B, commercial risk model score 29 provides for a greater accuracy to calculate potential business risk for default. Block B provides this greater accuracy by combining individual modules scores M1-M10, determined in commercial data 1.

Tables 1-27, provided below, highlight some of the advantages of the present disclosure. It should be noted that, in addition to regression and specification testing, extensive out-of-time validation testing was conducted. Results these tests of the modules, including those modules based on business of various sizes, industry classification, and the number of trades saved in Dun and Bradstreet records, demonstrates that the present disclosure is highly effective at identifying the “Good” and “Bad” accounts. In general there is a significant improvement in the bad capture rate when concentrating on the worst scoring 20% of the businesses. On average there is about 25% improvement over the current method of identifying Good and Bad.

Other metrics with significant improvement include the Kolmogorov-Smimoff (KS), the Divergence Index, Information value and etc. On average the improvement in these statistics is about 60% over the current method.

TABLE 1
Comparison of Overall to accuracy for FIG. 2, Block B as compared to prior art.

| | CCS | | | | |
|---|---|---|---|---|---|
| | June 2008-June 2009 Validation Data | | | | |
| | | | | CCS Score | |
| | | | | (9 factors | |
| Bad % captured | Existing | CCS Score | | excluding | |
| Population % | CCS Score | (10 factors) | Improvement | DT) | Improvement |
| 10% | 34 | 40 | 17.6% | 39 | 14.7% |
| 20% | 51 | 62 | 21.6% | 59 | 15.7% |
| 30% | 65 | 74 | | 70 | |
| 40% | 74 | 81 | | 78 | |
| 50% | 80 | 86 | | 84 | |
| 60% | 86 | 89 | | 88 | |
| 70% | 90 | 93 | | 92 | |
| 80% | 94 | 96 | | 95 | |
| 90% | 97 | 98 | | 98 | |
| 100% | 100 | 100 | | 100 | |
| KS | 38 | 48 | 26.3% | 43 | 13.2% |
| PI | 47.88 | 58.20 | 21.6% | 54.52 | 13.9% |
| KL Information Value | 0.42 | 0.65 | 54.8% | 0.56 | 33.3% |
| Information Value | 0.80 | 1.25 | 56.3% | 1.07 | 33.8% |
| Divergence | 1.14 | 1.78 | 56.1% | 1.46 | 28.1% |
| Mean of Goods | 500.56 | 511.78 | | 506.62 | |
| SD of Goods | 71.66 | 47.68 | | 46.34 | |
| Mean of Bads | 421.18 | 446.06 | | 449.08 | |
| SD of Bads | 103.54 | 64.34 | | 61.18 | |

| | |
|---|---|
| Population | 1,207,908 |
| Bads | 91,697 |
| Bad Rate | 7.59% |

TABLE 2
Comparison by business size, e.g., small business, for accuracy for FIG. 2, Block B
as compared to prior art.

| | Micro Biz | | | | |
|---|---|---|---|---|---|
| | June 2008-June 2009 Validation Data | | | | |
| | | | | CCS Score | |
| | | | | (9 factors | |
| Bad % captured | Existing | CCS Score | | excluding | |
| Population % | CCS Score | (10 factors) | Improvement | DT) | Improvement |
| 10% | 38 | 42 | 10.5% | 42 | 10.5% |
| 20% | 52 | 66 | 26.9% | 62 | 19.2% |
| 30% | 66 | 76 | | 72 | |
| 40% | 74 | 82 | | 79 | |
| 50% | 80 | 86 | | 84 | |
| 60% | 85 | 90 | | 88 | |
| 70% | 90 | 93 | | 92 | |
| 80% | 94 | 96 | | 95 | |
| 90% | 97 | 98 | | 98 | |
| 100% | 100 | 100 | | 100 | |
| KS | 39 | 50 | 28.2% | 45 | 15.4% |
| PI | 48.60 | 60.12 | 23.7% | 56.52 | 16.3% |
| KL Information Value | 0.48 | 0.71 | 47.9% | 0.62 | 29.2% |
| Information Value | 0.89 | 1.36 | 52.8% | 1.18 | 32.6% |
| Divergence | 1.30 | 2.02 | 55.4% | 1.72 | 32.3% |
| Mean of Goods | 494.58 | 518.22 | | 514.62 | |
| SD of Goods | 70.50 | 45.18 | | 45.22 | |
| Mean of Bads | 410.54 | 452.00 | | 453.52 | |
| SD of Bads | 105.72 | 63.36 | | 62.02 | |

| | |
|---|---|
| Population | 679,555 |
| Bads | 46,934 |
| Bad Rate | 6.91% |

TABLE 3
Comparison by business size, e.g., micro business, for accuracy for FIG. 2, Block B
as compared to prior art.

| | Small Biz | | | | |
|---|---|---|---|---|---|
| | June 2008-June 2009 Validation Data | | | | |
| | | | | CCS Score | |
| | | | | (9 factors | |
| Bad % captured | Existing | CCS Score | | excluding | |
| Population % | CCS Score | (10 factors) | Improvement | DT) | Improvement |
| 10% | 32 | 38 | #DIV/0! | 36 | #DIV/0! |
| 20% | 51 | 59 | #DIV/0! | 55 | #DIV/0! |
| 30% | 65 | 72 | | 67 | |
| 40% | 74 | 79 | | 76 | |
| 50% | 81 | 84 | | 82 | |
| 60% | 86 | 88 | | 87 | |
| 70% | 91 | 92 | | 91 | |
| 80% | 95 | 95 | | 94 | |
| 90% | 98 | 98 | | 98 | |
| 100% | 100 | 100 | | 100 | |
| KS | 38 | 46 | #DIV/0! | 49 | #DIV/0! |
| PI | 48.56 | 55.56 | #DIV/0! | 51.40 | #DIV/0! |
| KL Information Value | 0.41 | 0.58 | #DIV/0! | 0.49 | #DIV/0! |
| Information Value | 0.81 | 1.12 | #DIV/0! | 0.93 | #DIV/0! |
| Divergence | 1.02 | 1.56 | #DIV/0! | 1.20 | #DIV/0! |
| Mean of Goods | 508.40 | 503.34 | | 496.16 | |
| SD of Goods | 72.40 | 49.52 | | 45.70 | |
| Mean of Bads | 432.32 | 439.82 | | 444.44 | |
| SD of Bads | 99.98 | 64.78 | | 59.94 | |

| | |
|---|---|
| Population | 528,353 |
| Bads | 44,763 |
| Bad Rate | 8.47% |

TABLE 4
Comparison by a small business, e.g., construction, for accuracy for FIG. 2, Block B
as compared to prior art.

| | Construction | | | | |
|---|---|---|---|---|---|
| | Out-of-time Validation Data | | | | |
| | | | | CCS Score | |
| | | | | (9 factors | |
| Bad % captured | Existing | CCS Score | | excluding | |
| Population % | CCS Score | (10 factors) | Improvement | DT) | Improvement |
| 10% | 35 | 39 | 11.4% | 38 | 8.6% |
| 20% | 52 | 60 | 15.4% | 59 | 13.5% |
| 30% | 67 | 75 | | 72 | |
| 40% | 76 | 83 | | 80 | |
| 50% | 82 | 88 | | 86 | |
| 60% | 88 | 91 | | 90 | |
| 70% | 92 | 94 | | 93 | |
| 80% | 95 | 96 | | 96 | |
| 90% | 98 | 98 | | 98 | |
| 100% | 100 | 100 | | 100 | |
| KS | 42 | 50 | 19.0% | 46 | 9.5% |
| PI | 52.24 | 60.96 | 16.7% | 58.12 | 11.3% |
| KL Information | 0.50 | 0.70 | 40.0% | 0.63 | 26.0% |
| Value | | | | | |
| Information | 0.98 | 1.39 | 41.8% | 1.23 | 25.5% |
| Value | | | | | |
| Divergence | 1.30 | 1.86 | 43.1% | 1.60 | 23.1% |
| Mean of Goods | 497.74 | 507.56 | | 503.84 | |
| SD of Goods | 71.20 | 47.88 | | 47.26 | |
| Mean of Bads | 412.44 | 439.80 | | 442.40 | |
| SD of Bads | 102.82 | 62.66 | | 60.20 | |

| | |
|---|---|
| Population | 146,465 |
| Bads | 14,651 |
| Bad Rate | 10.00% |

TABLE 5
Comparison by a small business, e.g., manufacturing, for accuracy for FIG. 2, Block B
as compared to prior art.

| | Manufacturing | | | | |
|---|---|---|---|---|---|
| | Out-of-time Validation Data | | | | |
| | | | | CCS Score | |
| | | | | (9 factors | |
| Bad % captured | Existing CCS | CCS Score | | excluding | |
| Population % | Score | (10 factors) | Improvement | DT) | Improvement |
| 10% | 32 | 38 | 5.6% | 36 | 0.0% |
| 20% | 48 | 59 | 3.5% | 57 | 0.0% |
| 30% | 64 | 73 | | 69 | |
| 40% | 73 | 81 | | 77 | |
| 50% | 80 | 86 | | 84 | |
| 60% | 85 | 90 | | 88 | |
| 70% | 90 | 93 | | 92 | |
| 80% | 94 | 96 | | 95 | |
| 90% | 97 | 98 | | 98 | |
| 100% | 100 | 100 | | 100 | |
| KS | 37 | 47 | 9.3% | 43 | 0.0% |
| PI | 46.88 | 58.28 | 7.1% | 54.44 | 0.0% |
| KL | 0.40 | 0.63 | 14.5% | 0.55 | 0.0% |
| Information | | | | | |
| Value | | | | | |
| Information | 0.78 | 1.25 | 17.9% | 1.06 | 0.0% |
| Value | | | | | |
| Divergence | 0.98 | 1.66 | 23.9% | 1.34 | 0.0% |
| Mean of | 496.68 | 504.58 | | 498.94 | |
| Goods | | | | | |
| SD of Goods | 73.14 | 49.80 | | 47.96 | |
| Mean of | 421.84 | 438.78 | | 441.82 | |
| Bads | | | | | |
| SD of Bads | 99.38 | 62.68 | | 60.22 | |

| | |
|---|---|
| Population | 73,226 |
| Bads | 6,862 |
| Bad Rate | 9.37% |

TABLE 6
Comparison by a small business, e.g., financial, real-estate, for accuracy for FIG. 2, Block B
as compared to prior art.

| | Finance/Insurance/Real Estate | | | | |
|---|---|---|---|---|---|
| | Out-of-time Validation Data | | | | |
| | | | | CCS Score | |
| Bad % captured | Existing CCS | CCS Score | | (9 factors | |
| Population % | Score | (10 factors) | Improvement | excluding DT) | Improvement |
| 10% | 33 | 39 | 38900.0% | 38 | 37900.0% |
| 20% | 50 | 58 | 28900.0% | 56 | 27900.0% |
| 30% | 63 | 71 | | 68 | |
| 40% | 72 | 79 | | 76 | |
| 50% | 78 | 85 | | 83 | |
| 60% | 83 | 89 | | 87 | |
| 70% | 89 | 92 | | 91 | |
| 80% | 93 | 95 | | 94 | |
| 90% | 97 | 98 | | 98 | |
| 100% | 100 | 100 | | 100 | |
| KS | 36 | 44 | #VALUE! | 41 | #VALUE! |
| PI | 45.04 | 55.24 | #VALUE! | 51.92 | #VALUE! |
| KL | 0.37 | 0.56 | #VALUE! | 0.50 | #VALUE! |
| Information | | | | | |
| Value | | | | | |
| Information | 0.71 | 1.10 | #VALUE! | 0.97 | #VALUE! |
| Value | | | | | |
| Divergence | 1.08 | 1.60 | #VALUE! | 1.34 | #VALUE! |
| Mean of | 511.72 | 519.56 | | 515.40 | |
| Goods | | | | | |
| SD of Goods | 68.14 | 46.60 | | 45.92 | |
| Mean of | 437.88 | 458.84 | | 460.64 | |
| Bads | | | | | |
| SD of Bads | 104.18 | 64.90 | | 62.16 | |

| | |
|---|---|
| Population | 93,615 |
| Bads | 6,593 |
| Bad Rate | 7.04% |

TABLE 7
Comparison by an industry, e.g., real-estate, for accuracy for FIG. 2, Block B
as compared to prior art.

| | Real Estate | | | | |
|---|---|---|---|---|---|
| | Out-of-time Validation Data | | | | |
| | | | | CCS Score | |
| | | | | (9 factors | |
| Bad % captured | Existing | CCS Score | | excluding | |
| Population % | CCS score | (10 factors) | Improvement | DT) | Improvement |
| 10% | 33 | 38 | 15.2% | 37 | 12.1% |
| 20% | 48 | 57 | 18.8% | 55 | 14.6% |
| 30% | 62 | 71 | | 67 | |
| 40% | 72 | 79 | | 76 | |
| 50% | 78 | 85 | | 83 | |
| 60% | 83 | 89 | | 88 | |
| 70% | 89 | 92 | | 91 | |
| 80% | 93 | 95 | | 94 | |
| 90% | 97 | 98 | | 98 | |
| 100% | 100 | 100 | | 100 | |
| KS | 35 | 44 | 25.7% | 40 | 14.3% |
| PI | 44.12 | 54.16 | 22.8% | 51.48 | 16.7% |
| KL Information | 0.36 | 0.54 | 50.0% | 0.49 | 36.1% |
| Value | | | | | |
| Information | 0.69 | 1.05 | 52.2% | 0.94 | 36.2% |
| Value | | | | | |
| Divergence | 1.00 | 1.50 | 50.0% | 1.28 | 28.0% |
| Mean of Goods | 510.48 | 517.68 | | 513.82 | |
| SD of Goods | 68.62 | 47.16 | | 46.64 | |
| Mean of Bads | 439.02 | 458.12 | | 459.40 | |
| SD of Bads | 101.96 | 64.48 | | 62.30 | |

| | |
|---|---|
| Population | 50,372 |
| Bads | 3,660 |
| Bad Rate | 7.27% |

TABLE 8
Comparison by an industry, e.g., retail, for accuracy for FIG. 2,
Block B as compared to prior art.

| | Retail | | | | |
|---|---|---|---|---|---|
| | Out-of-time Validation Data | | | | |
| | | | | CCS Score | |
| | | | | (9 factors | |
| Bad % captured | Existing | CCS Score | | excluding | |
| Population % | CCS Score | (10 factors) | Improvement | DT) | Improvement |
| 10% | 31 | 36 | 16.1% | 34 | 9.7% |
| 20% | 47 | 57 | 21.3% | 53 | 12.8% |
| 30% | 62 | 71 | | 66 | |
| 40% | 72 | 79 | | 75 | |
| 50% | 78 | 84 | | 81 | |
| 60% | 84 | 89 | | 86 | |
| 70% | 89 | 92 | | 90 | |
| 80% | 93 | 95 | | 94 | |
| 90% | 97 | 98 | | 97 | |
| 100% | 100 | 100 | | 100 | |
| KS | 35 | 45 | 28.6% | 39 | 11.4% |
| PI | 44.32 | 54.92 | 23.9% | 49.44 | 11.6% |
| KL Information | 0.35 | 0.55 | 57.1% | 0.44 | 25.7% |
| Value | | | | | |
| Information | 0.68 | 1.08 | 58.8% | 0.85 | 25.0% |
| Value | | | | | |
| Divergence | 0.86 | 1.44 | 67.4% | 1.10 | 27.9% |
| Mean of Goods | 485.44 | 496.16 | | 489.96 | |
| SD of Goods | 74.74 | 49.10 | | 46.32 | |
| Mean of Bads | 414.16 | 435.94 | | 440.04 | |
| SD of Bads | 99.58 | 62.12 | | 58.88 | |

| | |
|---|---|
| Population | 209,368 |
| Bads | 17,792 |
| Bad Rate | 8.50% |

TABLE 9
Comparison by an industry, e.g., construction, for accuracy for
FIG. 2, Block B as compared to prior art.

| | Construction | | | |
|---|---|---|---|---|
| | Out-of-time Validation Data | | | |
| | | | | CCS |
| | | | | Score (9 |
| | Existing | CCS | | factors |
| Bad % captured | CCS | Score (10 | | excluding |
| Population % | Score | factors) | Improvement | DT) |
| 10% | 38 | 41 | 7.9% | 41 |
| 20% | 53 | 63 | 18.9% | 61 |
| 30% | 68 | 77 | | 73 |
| 40% | 77 | 84 | | 81 |
| 50% | 83 | 88 | | 86 |
| 60% | 86 | 91 | | 90 |
| 70% | 91 | 94 | | 93 |
| 80% | 94 | 96 | | 95 |
| 90% | 98 | 98 | | 98 |
| 100% | 100 | 100 | | 100 |
| KS | 42 | 51 | 21.4% | 47 |
| PI | 52.12 | 61.96 | 18.9% | 58.64 |
| KL Information | 0.54 | 0.74 | 37.0% | 0.67 |
| Value | | | | |
| Information Value | 1.02 | 1.46 | 43.1% | 1.28 |
| Divergence | 1.44 | 2.08 | 44.4% | 1.80 |
| Mean of Goods | 493.16 | 513.18 | | 511.08 |
| SD of Goods | 69.16 | 44.06 | | 44.80 |
| Mean of Bads | 405.44 | 447.18 | | 448.68 |
| SD of Bads | 104.62 | 61.16 | | 60.54 |

| | |
|---|---|
| Population | 88,185 |
| Bads | 7,963 |
| Bad Rate | 9.03% |

TABLE 10
Comparison by an industry, e.g., manufacturing, for accuracy for
FIG. 2, Block B as compared to prior art.

| | Manufacturing | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 36 | 40 | 11.1% | 40 | 11.1% |
| 20% | 48 | 62 | 29.2% | 60 | 25.0% |
| 30% | 64 | 76 | | 71 | |
| 40% | 74 | 82 | | 79 | |
| 50% | 81 | 87 | | 85 | |
| 60% | 85 | 91 | | 89 | |
| 70% | 89 | 94 | | 92 | |
| 80% | 93 | 96 | | 95 | |
| 90% | 97 | 98 | | 98 | |
| 100% | 100 | 100 | | 100 | |
| KS | 37 | 50 | 35.1% | 45 | 21.6% |
| PI | 46.72 | 59.72 | 27.8% | 55.88 | 19.6% |
| KL Information | 0.43 | 0.67 | 55.8% | 0.59 | 37.2% |
| Value | | | | | |
| Information | 0.81 | 1.33 | 64.2% | 1.14 | 40.7% |
| Value | | | | | |
| Divergence | 1.04 | 1.82 | 75.0% | 1.54 | 48.1% |
| Mean of Goods | 489.68 | 511.00 | | 507.22 | |
| SD of Goods | 71.50 | 45.98 | | 45.14 | |
| Mean of Bads | 414.24 | 447.20 | | 449.62 | |
| SD of Bads | 100.78 | 60.66 | | 59.34 | |

| | |
|---|---|
| Population | 33,793 |
| Bads | 2,529 |
| Bad Rate | 7.48% |

TABLE 11
Comparison by an industry, e.g., Finance/Insurance/Real Estate,
for accuracy for FIG. 2, Block B as compared to prior art.

| | Finance/Insurance/Real Estate | | | | |
|---|---|---|---|---|---|
| | Out-of-time Validation Data | | | | |
| | | | | CCS | |
| | | CCS | | Score (9 | |
| Bad % | Existing | Score | | factors | |
| captured | CCS | (10 | Improve- | excluding | |
| Population % | Score | factors) | ment | DT) | Improvement |
| 10% | 35 | 42 | 20.0% | 41 | 17.1% |
| 20% | 50 | 60 | 20.0% | 56 | 12.0% |
| 30% | 64 | 73 | | 69 | |
| 40% | 72 | 80 | | 77 | |
| 50% | 78 | 85 | | 82 | |
| 60% | 83 | 89 | | 87 | |
| 70% | 88 | 92 | | 90 | |
| 80% | 93 | 95 | | 94 | |
| 90% | 97 | 98 | | 98 | |
| 100% | 100 | 100 | | 100 | |
| KS | 36 | 45 | 25.0% | 42 | 16.7% |
| PI | 44.60 | 56.16 | 25.9% | 52.32 | 17.3% |
| KL Information | 0.39 | 0.60 | 53.8% | 0.54 | 38.5% |
| Value | | | | | |
| Information | 0.73 | 1.16 | 58.9% | 1.01 | 38.4% |
| Value | | | | | |
| Divergence | 1.18 | 1.76 | 49.2% | 1.50 | 27.1% |
| Mean of Goods | 508.40 | 526.82 | | 524.74 | |
| SD of Goods | 66.04 | 42.40 | | 42.98 | |
| Mean of Bads | 433.62 | 468.62 | | 470.68 | |
| SD of Bads | 104.10 | 61.36 | | 60.44 | |

| | |
|---|---|
| Population | 56,929 |
| Bads | 3,557 |
| Bad Rate | 6.25% |

TABLE 12
Comparison by an industry, e.g., Real Estate, for accuracy
for FIG. 2, Block B as compared to prior art.

| | Real Estate | | | | |
|---|---|---|---|---|---|
| | Out-of-time Validation Data | | | | |
| | | | | CCS | |
| | | CCS | | Score | |
| Bad % | Existing | Score | | (9 factors | |
| captured | CCS | (10 | Improve- | excluding | |
| Population % | Score | factors) | ment | DT) | Improvement |
| 10% | 34 | 40 | 17.6% | 40 | 17.6% |
| 20% | 48 | 59 | 22.9% | 55 | 14.6% |
| 30% | 63 | 72 | | 68 | |
| 40% | 72 | 79 | | 77 | |
| 50% | 78 | 84 | | 82 | |
| 60% | 83 | 88 | | 86 | |
| 70% | 88 | 91 | | 90 | |
| 80% | 93 | 94 | | 94 | |
| 90% | 97 | 97 | | 97 | |
| 100% | 100 | 100 | | 100 | |
| KS | 35 | 44 | 25.7% | 41 | 17.1% |
| PI | 43.60 | 54.24 | 24.4% | 51.08 | 17.2% |
| KL Information | 0.37 | 0.57 | 54.1% | 0.51 | 37.8% |
| Value | | | | | |
| Information | 0.70 | 1.08 | 54.3% | 0.96 | 37.1% |
| Value | | | | | |
| Divergence | 1.06 | 1.60 | 50.9% | 1.38 | 30.2% |
| Mean of Goods | 507.48 | 526.00 | | 523.92 | |
| SD of Goods | 66.26 | 42.16 | | 43.10 | |
| Mean of Bads | 436.40 | 470.98 | | 471.74 | |
| SD of Bads | 101.12 | 60.38 | | 59.88 | |

| | |
|---|---|
| Population | 31,257 |
| Bads | 1,982 |
| Bad Rate | 6.34% |

TABLE 13
Comparison by an industry, e.g., Retail, for accuracy for FIG. 2,
Block B as compared to prior art.

| | Retail | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 34 | 36 | 5.9% | 36 | 5.9% |
| 20% | 48 | 59 | 22.9% | 55 | 14.6% |
| 30% | 62 | 73 | | 68 | |
| 40% | 72 | 81 | | 76 | |
| 50% | 79 | 85 | | 82 | |
| 60% | 84 | 89 | | 87 | |
| 70% | 89 | 93 | | 91 | |
| 80% | 93 | 95 | | 94 | |
| 90% | 97 | 98 | | 98 | |
| 100% | 100 | 100 | | 100 | |
| KS | 35 | 47 | 34.3% | 41 | 17.1% |
| PI | 45.00 | 56.40 | 25.3% | 51.36 | 14.1% |
| KL Information | 0.38 | 0.58 | 52.6% | 0.49 | 28.9% |
| Value | | | | | |
| Information | 0.72 | 1.16 | 61.1% | 0.94 | 30.6% |
| Value | | | | | |
| Divergence | 0.94 | 1.54 | 63.8% | 1.28 | 36.2% |
| Mean of Goods | 478.20 | 500.04 | | 494.74 | |
| SD of Goods | 74.38 | 46.62 | | 44.88 | |
| Mean of Bads | 403.22 | 440.70 | | 442.62 | |
| SD of Bads | 101.98 | 59.92 | | 58.70 | |

| | |
|---|---|
| Population | 110,192 |
| Bads | 8,853 |
| Bad Rate | 8.03% |

TABLE 14
Comparison by an industry, e.g., construction, for accuracy for
FIG. 2, Block B as compared to prior art.

| | Construction | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 31 | 35 | 12.9% | 34 | 9.7% |
| 20% | 52 | 58 | 11.5% | 55 | 5.8% |
| 30% | 67 | 72 | | 69 | |
| 40% | 78 | 81 | | 79 | |
| 50% | 84 | 87 | | 85 | |
| 60% | 89 | 91 | | 90 | |
| 70% | 93 | 94 | | 94 | |
| 80% | 96 | 96 | | 96 | |
| 90% | 98 | 98 | | 98 | |
| 100% | 100 | 100 | | 100 | |
| KS | 43 | 47 | 9.3% | 44 | 2.3% |
| PI | 54.04 | 58.92 | 9.0% | 56.24 | 4.1% |
| KL Information | 0.50 | 0.63 | 26.0% | 0.56 | 12.0% |
| Value | | | | | |
| Information | 1.04 | 1.27 | 22.1% | 1.14 | 9.6% |
| Value | | | | | |
| Divergence | 1.18 | 1.60 | 35.6% | 1.32 | 11.9% |
| Mean of Goods | 504.90 | 498.80 | | 492.60 | |
| SD of Goods | 73.72 | 52.10 | | 48.78 | |
| Mean of Bads | 420.80 | 431.00 | | 434.92 | |
| SD of Bads | 99.98 | 63.26 | | 58.94 | |

| | |
|---|---|
| Population | 58,280 |
| Bads | 6,688 |
| Bad Rate | 11.48% |

TABLE 15
Comparison by an industry, e.g., manufacturing, for accuracy for
FIG. 2, Block B as ompared to prior art.

| | Manufacturing | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 30 | 36 | 20.0% | 33 | 10.0% |
| 20% | 50 | 56 | 12.0% | 53 | 6.0% |
| 30% | 65 | 70 | | 67 | |
| 40% | 74 | 79 | | 75 | |
| 50% | 81 | 85 | | 82 | |
| 60% | 87 | 89 | | 87 | |
| 70% | 91 | 93 | | 91 | |
| 80% | 95 | 96 | | 95 | |
| 90% | 98 | 98 | | 98 | |
| 100% | 100 | 100 | | 100 | |
| KS | 39 | 44 | 12.8% | 41 | 5.1% |
| PI | 49.32 | 56.40 | 14.4% | 51.76 | 4.9% |
| KL Information | 0.42 | 0.58 | 38.1% | 0.49 | 16.7% |
| Value | | | | | |
| Information | 0.84 | 1.16 | 38.1% | 0.95 | 13.1% |
| Value | | | | | |
| Divergence | 0.98 | 1.46 | 49.0% | 1.16 | 18.4% |
| Mean of Goods | 502.90 | 498.84 | | 491.56 | |
| SD of Goods | 74.02 | 52.32 | | 49.18 | |
| Mean of Bads | 426.26 | 433.86 | | 437.26 | |
| SD of Bads | 98.28 | 63.32 | | 60.28 | |

| | |
|---|---|
| Population | 39,433 |
| Bads | 4,333 |
| Bad Rate | 10.99% |

TABLE 16
Comparison by an industry, e.g., Finance/Insurance/Real Estate,
for accuracy for FIG. 2, Block B as compared to prior art.

| | Finance/Insurance/Real Estate | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 31 | 36 | 16.1% | 34 | 9.7% |
| 20% | 50 | 54 | 8.0% | 53 | 6.0% |
| 30% | 63 | 69 | | 67 | |
| 40% | 73 | 77 | | 76 | |
| 50% | 80 | 84 | | 81 | |
| 60% | 86 | 88 | | 86 | |
| 70% | 90 | 92 | | 91 | |
| 80% | 94 | 95 | | 95 | |
| 90% | 97 | 98 | | 98 | |
| 100% | 100 | 100 | | 100 | |
| KS | 36 | 43 | 19.4% | 40 | 11.1% |
| PI | 46.48 | 53.08 | 14.2% | 50.28 | 8.2% |
| KL Information | 0.37 | 0.52 | 40.5% | 0.45 | 21.6% |
| Value | | | | | |
| Information | 0.74 | 1.01 | 36.5% | 0.89 | 20.3% |
| Value | | | | | |
| Divergence | 1.00 | 1.36 | 36.0% | 1.16 | 16.0% |
| Mean of Goods | 516.96 | 508.02 | | 500.58 | |
| SD of Goods | 71.02 | 50.46 | | 46.54 | |
| Mean of Bads | 442.88 | 447.36 | | 448.88 | |
| SD of Bads | 104.04 | 67.02 | | 62.08 | |

| | |
|---|---|
| Population | 36,686 |
| Bads | 3,036 |
| Bad Rate | 8.28% |

TABLE 17
Comparison by an industry, e.g., Real Estate, for accuracy for
FIG. 2, Block B as compared to prior art.

| | Real Estate | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 30 | 36 | 20.0% | 34 | 13.3% |
| 20% | 48 | 54 | 12.5% | 52 | 8.3% |
| 30% | 62 | 68 | | 65 | |
| 40% | 71 | 77 | | 75 | |
| 50% | 78 | 84 | | 81 | |
| 60% | 85 | 88 | | 87 | |
| 70% | 90 | 92 | | 91 | |
| 80% | 95 | 96 | | 95 | |
| 90% | 98 | 98 | | 98 | |
| 100% | 100 | 100 | | 100 | |
| KS | 35 | 41 | 17.1% | 39 | 11.4% |
| PI | 45.48 | 52.92 | 16.4% | 50.04 | 10.0% |
| KL Information | 0.36 | 0.51 | 41.7% | 0.45 | 25.0% |
| Value | | | | | |
| Information | 0.72 | 1.00 | 38.9% | 0.88 | 22.2% |
| Value | | | | | |
| Divergence | 0.94 | 1.32 | 40.4% | 1.14 | 21.3% |
| Mean of Goods | 515.52 | 503.70 | | 496.84 | |
| SD of Goods | 72.16 | 51.58 | | 47.44 | |
| Mean of Bads | 442.12 | 442.92 | | 444.82 | |
| SD of Bads | 102.86 | 65.82 | | 61.94 | |

| | |
|---|---|
| Population | 19,115 |
| Bads | 1,678 |
| Bad Rate | 8.78% |

TABLE 18
Comparison by an industry, e.g., Retail, for accuracy for FIG. 2,
Block B as compared to prior art.

| | Retail | | | | |
|---|---|---|---|---|---|
| | Out-of-time Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 29 | 35 | 20.7% | 32 | 10.3% |
| 20% | 47 | 56 | 19.1% | 51 | 8.5% |
| 30% | 62 | 70 | | 64 | |
| 40% | 72 | 78 | | 73 | |
| 50% | 79 | 83 | | 80 | |
| 60% | 85 | 88 | | 85 | |
| 70% | 90 | 91 | | 90 | |
| 80% | 94 | 95 | | 94 | |
| 90% | 97 | 98 | | 97 | |
| 100% | 100 | 100 | | 100 | |
| KS | 35 | 43 | 22.9% | 37 | 5.7% |
| PI | 44.76 | 53.32 | 19.1% | 47.00 | 5.0% |
| KL Information | 0.34 | 0.52 | 52.9% | 0.40 | 17.6% |
| Value | | | | | |
| Information | 0.68 | 1.01 | 48.5% | 0.76 | 11.8% |
| Value | | | | | |
| Divergence | 0.80 | 1.32 | 65.0% | 0.94 | 17.5% |
| Mean of Goods | 493.58 | 491.80 | | 484.58 | |
| SD of Goods | 74.34 | 51.38 | | 47.30 | |
| Mean of Bads | 425.00 | 431.24 | | 437.48 | |
| SD of Bads | 95.90 | 63.86 | | 58.94 | |

| | |
|---|---|
| Population | 99,176 |
| Bads | 8,939 |
| Bad Rate | 9.01% |

TABLE 19
Comparison by a number of trades, e.g., no trades, OVERALL for
accuracy for FIG. 2, Block B as compared to prior art.

| | No Trade | | |
|---|---|---|---|
| | June 2008-June 2009 Validation Data | | |
| | | CCS Score | |
| Bad % captured | Existing | (base | |
| Population % | CCS Score | factors) | Improvement |
| 10% | 19 | 18 | −5.3% |
| 20% | 33 | 31 | −6.1% |
| 30% | 47 | 45 | |
| 40% | 57 | 56 | |
| 50% | 65 | 66 | |
| 60% | 74 | 77 | |
| 70% | 83 | 83 | |
| 80% | 89 | 91 | |
| 90% | 96 | 96 | |
| 100% | 100 | 100 | |
| KS | 19 | 18 | −5.3% |
| PI | 23.40 | 23.56 | 0.7% |
| KL Information Value | 0.10 | 0.09 | −10.0% |
| Information Value | 0.21 | 0.19 | −9.5% |
| Divergence | 0.16 | 0.18 | 12.5% |
| Mean of Goods | 411.40 | 462.78 | |
| SD of Goods | 19.50 | 22.20 | |
| Mean of Bads | 403.40 | 453.16 | |
| SD of Bads | 18.42 | 21.64 | |

| | |
|---|---|
| Population | 29,761 |
| Bads | 1,182 |
| Bad Rate | 3.97% |

TABLE 20
Comparison by a number of trades, e.g., 1-2 trades, OVERALL for
accuracy for FIG. 2, Block B as compared to prior art.

| | 1-2 Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 42 | 50 | 19.0% | 45 | 7.1% |
| 20% | 52 | 65 | 25.0% | 59 | 13.5% |
| 30% | 63 | 72 | | 68 | |
| 40% | 72 | 77 | | 75 | |
| 50% | 78 | 82 | | 80 | |
| 60% | 84 | 87 | | 85 | |
| 70% | 89 | 91 | | 90 | |
| 80% | 93 | 95 | | 94 | |
| 90% | 97 | 98 | | 98 | |
| 100% | 100 | 100 | | 100 | |
| KS | 34 | 47 | 38.2% | 41 | 20.6% |
| PI | 45.88 | 55.88 | 21.8% | 51.12 | 11.4% |
| KL Information | 0.49 | 0.69 | 40.8% | 0.56 | 14.3% |
| Value | | | | | |
| Information | 0.87 | 1.25 | 43.7% | 1.01 | 16.1% |
| Value | | | | | |
| Divergence | 1.50 | 1.96 | 30.7% | 1.74 | 16.0% |
| Mean of Goods | 472.90 | 540.38 | | 536.56 | |
| SD of Goods | 61.80 | 34.70 | | 37.76 | |
| Mean of Bads | 394.22 | 489.94 | | 485.40 | |
| SD of Bads | 103.64 | 57.24 | | 58.90 | |

| | |
|---|---|
| Population | 211702 |
| Bads | 9,034 |
| Bad Rate | 4.27% |

TABLE 21
Comparison by a number of trades, e.g., 3 or more trades, OVERALL
for accuracy for FIG. 2, Block B as compared to prior art.

| | 3 or more Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 35 | 38 | 8.6% | 37 | 5.7% |
| 20% | 56 | 61 | 8.9% | 57 | 1.8% |
| 30% | 69 | 74 | | 69 | |
| 40% | 77 | 81 | | 77 | |
| 50% | 83 | 86 | | 83 | |
| 60% | 87 | 90 | | 88 | |
| 70% | 91 | 93 | | 92 | |
| 80% | 95 | 96 | | 95 | |
| 90% | 98 | 98 | | 98 | |
| 100% | 100 | 100 | | 100 | |
| KS | 42 | 48 | 14.3% | 43 | 2.4% |
| PI | 52.36 | 58.12 | 11.0% | 53.80 | 2.8% |
| KL Information | 0.50 | 0.63 | 26.0% | 0.54 | 8.0% |
| Value | | | | | |
| Information | 0.97 | 1.24 | 27.8% | 1.04 | 7.2% |
| Value | | | | | |
| Divergence | 1.32 | 1.70 | 28.8% | 1.36 | 3.0% |
| Mean of Goods | 509.78 | 504.14 | | 499.22 | |
| SD of Goods | 71.22 | 47.96 | | 45.78 | |
| Mean of Bads | 424.42 | 439.82 | | 444.10 | |
| SD of Bads | 103.78 | 62.56 | | 59.90 | |

| | |
|---|---|
| Population | 966,445 |
| Bads | 81,481 |
| Bad Rate | 8.43% |

TABLE 22
Comparison by a number of trades, e.g., no trades, for a MICRO
Business for accuracy for FIG. 2, Block B as compared to prior art.

| | No Trade | | |
|---|---|---|---|
| | June 2008-June 2009 Validation Data | | |
| Bad % captured | Existing | CCS Score | |
| Population % | CCS Score | (base factors) | Improvement |
| 10% | 18 | 18 | 0.0% |
| 20% | 34 | 34 | 0.0% |
| 30% | 47 | 47 | |
| 40% | 56 | 58 | |
| 50% | 65 | 69 | |
| 60% | 74 | 76 | |
| 70% | 83 | 84 | |
| 80% | 90 | 91 | |
| 90% | 95 | 96 | |
| 100% | 100 | 100 | |
| KS | 18 | 20 | 11.1% |
| PI | 23.12 | 25.24 | 9.2% |
| KL Information Value | 0.10 | 0.10 | 0.0% |
| Information Value | 0.19 | 0.22 | 15.8% |
| Divergence | 0.16 | 0.22 | 37.5% |
| Mean of Goods | 411.28 | 469.88 | |
| SD of Goods | 19.24 | 18.32 | |
| Mean of Bads | 403.44 | 461.36 | |
| SD of Bads | 18.14 | 17.62 | |

| | |
|---|---|
| Population | 23,151 |
| Bads | 867 |
| Bad Rate | 3.74% |

TABLE 23
Comparison by a number of trades, e.g., 1-2 trades, for a MICRO
Business for accuracy for FIG. 2, Block B as compared to prior art.

| | 1-2 Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 45 | 53 | 17.8% | 49 | 8.9% |
| 20% | 55 | 67 | 21.8% | 63 | 14.5% |
| 30% | 66 | 74 | | 70 | |
| 40% | 74 | 79 | | 76 | |
| 50% | 80 | 84 | | 81 | |
| 60% | 85 | 88 | | 86 | |
| 70% | 90 | 92 | | 90 | |
| 80% | 94 | 95 | | 94 | |
| 90% | 98 | 98 | | 98 | |
| 100% | 100 | 100 | | 100 | |
| KS | 37 | 49 | 32.4% | 44 | 18.9% |
| PI | 49.32 | 58.24 | 18.1% | 53.68 | 8.8% |
| KL Information | 0.54 | 0.77 | 42.6% | 0.64 | 18.5% |
| Value | | | | | |
| Information | 0.96 | 1.39 | 44.8% | 1.15 | 19.8% |
| Value | | | | | |
| Divergence | 1.88 | 2.30 | 22.3% | 2.14 | 13.8% |
| Mean of Goods | 473.84 | 541.92 | | 539.36 | |
| SD of Goods | 60.34 | 33.26 | | 36.60 | |
| Mean of Bads | 387.48 | 489.44 | | 483.84 | |
| SD of Bads | 105.02 | 56.06 | | 59.42 | |

| | |
|---|---|
| Population | 167,279 |
| Bads | 7,157 |
| Bad Rate | 4.28% |

TABLE 24
Comparison by a number of trades, e.g., 3 or more trades, for a MICRO
Business for accuracy for FIG. 2, Block B as compared to prior art.

| | 3 or more Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 37 | 39 | 5.4% | 39 | 5.4% |
| 20% | 58 | 63 | 8.6% | 60 | 3.4% |
| 30% | 71 | 76 | | 71 | |
| 40% | 78 | 83 | | 79 | |
| 50% | 83 | 87 | | 85 | |
| 60% | 88 | 91 | | 89 | |
| 70% | 91 | 94 | | 92 | |
| 80% | 95 | 96 | | 95 | |
| 90% | 98 | 98 | | 98 | |
| 100% | 100 | 100 | | 100 | |
| KS | 44 | 50 | 13.6% | 45 | 2.3% |
| PI | 53.96 | 60.32 | 11.8% | 55.84 | 3.5% |
| KL Information | 0.54 | 0.69 | 27.8% | 0.59 | 9.3% |
| Value | | | | | |
| Information | 1.05 | 1.36 | 29.5% | 1.13 | 7.6% |
| Value | | | | | |
| Divergence | 1.50 | 1.88 | 25.3% | 1.58 | 5.3% |
| Mean of Goods | 506.08 | 508.46 | | 505.12 | |
| SD of Goods | 71.00 | 46.14 | | 45.32 | |
| Mean of Bads | 414.94 | 443.18 | | 446.46 | |
| SD of Bads | 106.42 | 61.32 | | 60.52 | |

| | |
|---|---|
| Population | 489,125 |
| Bads | 38,910 |
| Bad Rate | 7.96% |

TABLE 25
Comparison by a number of trades, e.g., no trades, for a SMALL
Business for accuracy for FIG. 2, Block B as compared to prior art.

| | No Trade | | |
|---|---|---|---|
| | June 2008-June 2009 Validation Data | | |
| | | CCS Score | |
| Bad % captured | Existing | (base | |
| Population % | CCS Score | factors) | Improvement |
| 10% | 17 | 21 | 23.5% |
| 20% | 33 | 36 | 9.1% |
| 30% | 48 | 47 | |
| 40% | 57 | 58 | |
| 50% | 64 | 67 | |
| 60% | 76 | 75 | |
| 70% | 83 | 85 | |
| 80% | 90 | 93 | |
| 90% | 97 | 96 | |
| 100% | 100 | 100 | |
| KS | 20 | 21 | 5.0% |
| PI | 24.24 | 26.64 | 9.9% |
| KL Information Value | 0.11 | 0.12 | 9.1% |
| Information Value | 0.23 | 0.26 | 13.0% |
| Divergence | 0.18 | 0.20 | 11.1% |
| Mean of Goods | 411.84 | 437.66 | |
| SD of Goods | 20.34 | 15.44 | |
| Mean of Bads | 403.28 | 430.62 | |
| SD of Bads | 19.22 | 14.54 | |

| | |
|---|---|
| Population | 6,610 |
| Bads | 315 |
| Bad Rate | 4.77% |

TABLE 26
Comparison by a number of trades, e.g., 1-2 trades, for a SMALL
Business for accuracy for FIG. 2, Block B as compared to prior art.

| | 1-2 Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 29 | 40 | 37.9% | 32 | 10.3% |
| 20% | 41 | 56 | 36.6% | 47 | 14.6% |
| 30% | 52 | 64 | | 58 | |
| 40% | 63 | 71 | | 67 | |
| 50% | 72 | 78 | | 76 | |
| 60% | 79 | 84 | | 81 | |
| 70% | 85 | 88 | | 87 | |
| 80% | 91 | 93 | | 92 | |
| 90% | 96 | 97 | | 97 | |
| 100% | 100 | 100 | | 100 | |
| KS | 24 | 37 | 54.2% | 29 | 20.8% |
| PI | 33.08 | 46.12 | 39.4% | 39.20 | 18.5% |
| KL Information | 0.21 | 0.44 | 109.5% | 0.29 | 38.1% |
| Value | | | | | |
| Information | 0.40 | 0.80 | 100.0% | 0.54 | 35.0% |
| Value | | | | | |
| Divergence | 0.52 | 1.12 | 115.4% | 0.72 | 38.5% |
| Mean of Goods | 469.34 | 534.60 | | 525.98 | |
| SD of Goods | 66.88 | 39.10 | | 40.06 | |
| Mean of Bads | 419.98 | 491.80 | | 491.32 | |
| SD of Bads | 93.86 | 61.48 | | 56.54 | |

| | |
|---|---|
| Population | 44,423 |
| Bads | 1,877 |
| Bad Rate | 4.23% |

TABLE 27
Comparison by a number of trades, e.g., 3 or more trades, for a SMALL
Business for accuracy for FIG. 2, Block B as compared to prior art.

| | 3 or more Trades | | | | |
|---|---|---|---|---|---|
| | June 2008-June 2009 Validation Data | | | | |
| | | CCS | | CCS Score | |
| Bad % | Existing | Score | | (9 factors | |
| captured | CCS | (10 | Improve- | excluding | Improve- |
| Population % | Score | factors) | ment | DT) | ment |
| 10% | 33 | 37 | 12.1% | 35 | 6.1% |
| 20% | 54 | 59 | 9.3% | 55 | 1.9% |
| 30% | 67 | 72 | | 67 | |
| 40% | 76 | 79 | | 76 | |
| 50% | 83 | 85 | | 82 | |
| 60% | 88 | 89 | | 87 | |
| 70% | 92 | 92 | | 91 | |
| 80% | 95 | 95 | | 94 | |
| 90% | 98 | 98 | | 98 | |
| 100% | 100 | 100 | | 100 | |
| KS | 41 | 46 | 12.2% | 41 | 0.0% |
| PI | 51.56 | 55.92 | 8.5% | 51.56 | 0.0% |
| KL Information | 0.47 | 0.58 | 23.4% | 0.49 | 4.3% |
| Value | | | | | |
| Information | 0.93 | 1.13 | 21.5% | 0.94 | 1.1% |
| Value | | | | | |
| Divergence | 1.18 | 1.54 | 30.5% | 1.20 | 1.7% |
| Mean of Goods | 513.62 | 499.64 | | 493.10 | |
| SD of Goods | 71.24 | 49.38 | | 45.42 | |
| Mean of Bads | 433.08 | 436.76 | | 441.96 | |
| SD of Bads | 100.54 | 63.52 | | 59.24 | |

| | |
|---|---|
| Population | 477,320 |
| Bads | 42,571 |
| Bad Rate | 8.92% |

Likewise, Block D, project star 37 provides for a greater accuracy to calculate potential business risk for default. Block D provides this greater accuracy by combining commercial risk model score 29 with consumer attributes 23, e.g., zip level consumer attributes 25. For example, this accuracy is illustrated by Table 28-33-below.

TABLE 28
FIG. 2, Block D Project Star improvement over prior art OVERALL
having ZIP level consumer attributes 25. See Contribution from
Zip Score column.

| | Scores Performance | | | |
|---|---|---|---|---|
| | June 2008-June 2009 Validation Data | | | |
| | | | | Contribution |
| Bad % captured | DNB-TU | Existing | Blended | from Zip |
| Population % | Zip Score | CCS | Score | Score |
| 10% | 30 | 26 | 35 | 34.6% |
| 20% | 45 | 47 | 52 | 10.6% |
| 30% | 53 | 60 | 64 | |
| 40% | 61 | 70 | 73 | |
| 50% | 69 | 77 | 79 | |
| 60% | 76 | 83 | 85 | |
| 70% | 83 | 89 | 90 | |
| 80% | 89 | 93 | 94 | |
| 90% | 95 | 97 | 97 | |
| 100% | 100 | 100 | 100 | |
| KS | 27 | 33 | 37 | 12.1% |
| PI | 32.04 | 41.28 | 46.84 | 13.5% |
| KL Information Value | 0.23 | 0.30 | 0.41 | 36.7% |
| Information Value | 0.41 | 0.58 | 0.77 | 32.8% |
| Divergence | 0.54 | 0.70 | 0.94 | 34.3% |
| Mean of Goods | 494.28 | 516.82 | 509.54 | |
| SD of Goods | 26.76 | 53.12 | 42.88 | |
| Mean of Bads | 474.18 | 472.06 | 462.12 | |
| SD of Bads | 35.92 | 61.74 | 59.5 | |

| | |
|---|---|
| Population | 2,094,451 |
| Bads | 148,262 |
| Bad Rate | 7.08% |

TABLE 29
FIG. 2, Block D Project Star improvement over prior art having ZIP
level consumer attributes 25 by Business Size, e.g., MICRO business.
See Contribution from Zip Score column.

| | Micro Biz | | | |
|---|---|---|---|---|
| | June 2008-June 2009 Validation Data | | | |
| Bad % captured | DNB-TU | Existing | Blended | Contribution |
| Population % | Zip Score | CCS | Score | from Zip Score |
| 10% | 33 | 24 | 34 | 41.7% |
| 20% | 43 | 44 | 53 | 20.5% |
| 30% | 51 | 60 | 64 | |
| 40% | 60 | 69 | 73 | |
| 50% | 68 | 76 | 79 | |
| 60% | 75 | 83 | 85 | |
| 70% | 82 | 88 | 89 | |
| 80% | 89 | 92 | 93 | |
| 90% | 95 | 97 | 97 | |
| 100% | 100 | 100 | 100 | |
| KS | 25 | 32 | 37 | 15.6% |
| PI | 31.12 | 38.80 | 46.24 | 19.2% |
| KL Information Value | 0.26 | 0.25 | 0.39 | 56.0% |
| Information Value | 0.44 | 0.50 | 0.75 | 50.0% |
| Divergence | 0.62 | 0.60 | 1.14 | 90.0% |
| Mean of Goods | 497.74 | 507.14 | 507.80 | |
| SD of Goods | 27.04 | 54.12 | 40.72 | |
| Mean of Bads | 475.52 | 464.98 | 462.80 | |
| SD of Bads | 39.90 | 61.68 | 58.12 | |

| | |
|---|---|
| Population | 1,001,513 |
| Bads | 61,746 |
| Bad Rate | 6.17% |

TABLE 30
FIG. 2, Block D Project Star improvement over prior art having ZIP
level consumer attributes 25 by Business Size, e.g., SMALL business.
See Contribution from Zip Score column.

| | Small Biz | | | |
|---|---|---|---|---|
| | June 2008-June 2009 Validation Data | | | |
| Bad % captured | DNB-TU | Existing | Blended | Contribution |
| Population % | Zip Score | CCS | Score | from Zip Score |
| 10% | 26 | 31 | 35 | 12.9% |
| 20% | 44 | 50 | 52 | 4.0% |
| 30% | 54 | 63 | 64 | |
| 40% | 61 | 72 | 73 | |
| 50% | 68 | 79 | 80 | |
| 60% | 75 | 85 | 86 | |
| 70% | 82 | 90 | 90 | |
| 80% | 88 | 94 | 94 | |
| 90% | 94 | 97 | 97 | |
| 100% | 100 | 100 | 100 | |
| KS | 26 | 36 | 37 | 2.8% |
| PI | 31.12 | 45.72 | 47.84 | 4.6% |
| KL Information Value | 0.20 | 0.37 | 0.42 | 13.5% |
| Information Value | 0.37 | 0.71 | 0.80 | 12.7% |
| Divergence | 0.44 | 0.90 | 1.16 | 28.9% |
| Mean of Goods | 491.04 | 525.84 | 511.18 | |
| SD of Goods | 26.10 | 50.52 | 44.72 | |
| Mean of Bads | 473.22 | 477.10 | 461.62 | |
| SD of Bads | 32.74 | 61.30 | 60.48 | |

| | |
|---|---|
| Population | 1,092,938 |
| Bads | 86,516 |
| Bad Rate | 7.92% |

TABLE 31
FIG. 2, Block D Project Star improvement over prior art having ZIP
level consumer attributes 25 according to trade data, e.g., NO TRADES.
See Contribution from Zip Score column.

| | No Trade | | | |
|---|---|---|---|---|
| | June 2008-June 2009 Validation Data | | | |
| Bad % captured | DNB-TU | Existing | Blended | Contribution |
| Population % | Zip Score | CCS | Score | from Zip Score |
| 10% | 18 | 20 | 22 | 10.0% |
| 20% | 28 | 34 | 40 | 17.6% |
| 30% | 40 | 47 | 51 | |
| 40% | 48 | 56 | 62 | |
| 50% | 58 | 67 | 72 | |
| 60% | 66 | 77 | 80 | |
| 70% | 75 | 84 | 86 | |
| 80% | 86 | 90 | 92 | |
| 90% | 94 | 97 | 97 | |
| 100% | 100 | 100 | 100 | |
| KS | 10 | 18 | 24 | 33.3% |
| PI | 13.12 | 25.48 | 32.28 | 26.7% |
| KL Information Value | 0.04 | 0.11 | 0.17 | 54.5% |
| Information Value | 0.08 | 0.22 | 0.34 | 54.5% |
| Divergence | 0.06 | 0.20 | 0.34 | 70.0% |
| Mean of Goods | 483.26 | 413.30 | 516.48 | |
| SD of Goods | 21.02 | 19.58 | 34.32 | |
| Mean of Bads | 477.84 | 404.68 | 496.44 | |
| SD of Bads | 22.04 | 18.12 | 33.16 | |

| | |
|---|---|
| Population | 73,151 |
| Bads | 3,876 |
| Bad Rate | 5.30% |

TABLE 32
FIG. 2, Block D Project Star improvement over prior art having ZIP
level consumer attributes 25 according to trade data, e.g., 1-2 trades.
See Contribution from Zip Score column.

| | 1-2 Trades | | | |
|---|---|---|---|---|
| | June 2008-June 2009 Validation Data | | | |
| Bad % captured | DNB-TU | Existing | Blended | Contribution |
| Population % | Zip Score | CCS | Score | from Zip Score |
| 10% | 16 | 24 | 25 | 4.2% |
| 20% | 28 | 37 | 38 | 2.7% |
| 30% | 40 | 52 | 53 | |
| 40% | 52 | 63 | 65 | |
| 50% | 61 | 71 | 74 | |
| 60% | 70 | 79 | 81 | |
| 70% | 79 | 86 | 88 | |
| 80% | 87 | 91 | 93 | |
| 90% | 94 | 96 | 97 | |
| 100% | 100 | 100 | 100 | |
| KS | 12 | 24 | 26 | 8.3% |
| PI | 16.12 | 31.12 | 34.12 | 9.6% |
| KL Information Value | 0.04 | 0.18 | 0.20 | 11.1% |
| Information Value | 0.08 | 0.34 | 0.40 | 17.6% |
| Divergence | 0.14 | 0.42 | 0.50 | 19.0% |
| Mean of Goods | 500.92 | 482.50 | 490.14 | |
| SD of Goods | 20.88 | 44.92 | 33.28 | |
| Mean of Bads | 493.26 | 452.78 | 466.28 | |
| SD of Bads | 26.46 | 56.10 | 42.50 | |

| | |
|---|---|
| Population | 301,968 |
| Bads | 11,665 |
| Bad Rate | 3.86% |

TABLE 33
FIG. 2, Block D Project Star improvement over prior art having ZIP
level consumer attributes 25 and according to trade data, e.g., 3 or
more trades. See Contribution from Zip Score column.

| | 3 or more Trades | | | |
|---|---|---|---|---|
| | June 2008-June 2009 Validation Data | | | |
| Bad % captured | DNB-TU | Existing | Blended | Contribution |
| Population % | Zip Score | CCS | Score | from Zip Score |
| 10% | 29 | 35 | 36 | 2.9% |
| 20% | 46 | 54 | 55 | 1.9% |
| 30% | 55 | 66 | 67 | |
| 40% | 62 | 74 | 75 | |
| 50% | 69 | 80 | 81 | |
| 60% | 76 | 86 | 86 | |
| 70% | 83 | 90 | 91 | |
| 80% | 89 | 94 | 94 | |
| 90% | 95 | 97 | 97 | |
| 100% | 100 | 100 | 100 | |
| KS | 28 | 39 | 40 | 2.6% |
| PI | 33.12 | 48.72 | 50.32 | 3.3% |
| KL Information Value | 0.24 | 0.44 | 0.47 | 6.8% |
| Information Value | 0.43 | 0.84 | 0.89 | 6.0% |
| Divergence | 0.56 | 1.12 | 1.32 | 17.9% |
| Mean of Goods | 493.54 | 527.62 | 512.80 | |
| SD of Goods | 27.66 | 47.70 | 43.80 | |
| Mean of Bads | 472.40 | 475.72 | 460.74 | |
| SD of Bads | 36.46 | 61.60 | 61.04 | |

| | |
|---|---|
| Population | 1,719,332 |
| Bads | 132,721 |
| Bad Rate | 7.72% |

Further, Block D, project star 37 provides for a greater accuracy by combining the commercial risk model score 29 with consumer attributes 23, e.g., individual level consumer attributes 27. For example, this accuracy is illustrated by Table 33-35-below.

TABLE 34
FIG. 2, Block D Project Star improvement over prior art OVERALL for
a SMALL BUSINESS to determine risk for default using INDIVIDUAL LEVEL
consumer attributes 27 and commercial risk model score 29.

| | Scores Performance | | | | | |
|---|---|---|---|---|---|---|
| | June 2008-June 2009 in-sample data | | | | | |
| | | | | | | Contribution |
| | DNB-TU | | New CCS | | Improvement | from |
| Bad % captured | Premium | Existing | (DT | Blended | over existing | Premium |
| Population % | Score | CCS | included) | Score | CCS | Score |
| 10% | 34 | 35 | 41 | 44 | 25.7% | 7.3% |
| 20% | 52 | 51 | 61 | 66 | 29.4% | 8.2% |
| 30% | 64 | 66 | 73 | 78 | | |
| 40% | 73 | 74 | 81 | 85 | | |
| 50% | 80 | 80 | 85 | 89 | | |
| 60% | 86 | 86 | 89 | 93 | | |
| 70% | 90 | 90 | 92 | 95 | | |
| 80% | 95 | 94 | 95 | 97 | | |
| 90% | 98 | 97 | 98 | 99 | | |
| 100% | 100 | 100 | 100 | 100 | | |
| KS | 37 | 39 | 47 | 52 | 33.3% | 10.6% |
| PI | 47.72 | 48.40 | 57.32 | 64.12 | 32.5% | 11.9% |
| KL Information Value | 0.41 | 0.43 | 0.63 | 0.79 | 83.7% | 25.4% |
| Information Value | 0.80 | 0.83 | 1.21 | 1.58 | 90.4% | 30.6% |
| Divergence | 1.14 | 1.18 | 1.74 | 2.32 | 96.6% | 33.3% |
| Mean of Goods | 498.46 | 505.02 | 511.98 | 482.42 | | |
| SD of Goods | 33.82 | 70.76 | 47.20 | 54.18 | | |
| Mean of Bads | 460.16 | 424.82 | 447.72 | 396.66 | | |
| SD of Bads | 55.86 | 103.54 | 63.70 | 77.14 | | |

| | |
|---|---|
| Population | 713,198 |
| Bads | 54,716 |
| Bad Rate | 7.67% |

TABLE 35
FIG. 2, Block D Project Star improvement over prior art OVERALL for
a MICRO-Businss to determine risk for default using INDIVIDUAL LEVEL
consumer attributes 27 and commercial risk model score 29.

| | Scores Performance | | | | | |
|---|---|---|---|---|---|---|
| | June 2008-June 2009 out-of-sample data | | | | | |
| | | | | | | Contribution |
| | DNB-TU | | New CCS | | Improvement | from |
| Bad % captured | Premium | Existing | (DT | Blended | over existing | Premium |
| Population % | Score | CCS | included) | Score | CCS | Score |
| 10% | 34 | 35 | 41 | 45 | 28.6% | 9.8% |
| 20% | 52 | 51 | 61 | 66 | 29.4% | 8.2% |
| 30% | 64 | 65 | 74 | 78 | | |
| 40% | 73 | 74 | 81 | 85 | | |
| 50% | 81 | 80 | 85 | 89 | | |
| 60% | 86 | 86 | 89 | 92 | | |
| 70% | 91 | 90 | 92 | 95 | | |
| 80% | 95 | 94 | 95 | 97 | | |
| 90% | 98 | 97 | 98 | 99 | | |
| 100% | 100 | 100 | 100 | 100 | | |
| KS | 37 | 38 | 47 | 52 | 36.8% | 10.6% |
| PI | 48.08 | 48.04 | 57.44 | 63.96 | 33.1% | 11.4% |
| KL Information Value | 0.41 | 0.43 | 0.63 | 0.79 | 83.7% | 25.4% |
| Information Value | 0.81 | 0.82 | 1.22 | 1.57 | 91.5% | 28.7% |
| Divergence | 1.16 | 1.18 | 1.74 | 2.34 | 98.3% | 34.5% |
| Mean of Goods | 498.48 | 505.06 | 511.90 | 482.36 | | |
| SD of Goods | 33.80 | 70.46 | 47.04 | 54 | | |
| Mean of Bads | 459.84 | 425.54 | 447.84 | 396.5 | | |
| SD of Bads | 56.18 | 103.28 | 63.52 | 77.4 | | |

| | |
|---|---|
| Population | 305,670 |
| Bads | 23,251 |
| Bad Rate | 7.61% |

With particular reference to commercial data 1 of database A, modules M1-M10 represent different attributes of risk of a business. As discussed above, the resultant default risk for the modules are then provided to determine a commercial risk model score 29, i.e., block B.

The modules within commercial data 1 include, but are not limited to: M1: firm-o-graphic and public record model, M2: geo-risk model, M3 industry risk model, M4: C & O rating, M5: current commercial credit score model, M6: long term payment behavior model, M7: long term trade behavior model, M8: short and long term financial strength model, M9: national rating from Moody's, Standard & Poors, Fitch, DBRS, AM Best, and M10: short term trade behavior model based on detail trade data.

Typically, each module represents a different attribute of a business and yields a numerical value according to a scale, e.g., 1-100. This numerical value or score correlates to a level of inherent default risk determined for the business according to the particular module. For example, a larger score, e.g., 100, represents a lower level of inherent default risk and a lower score, e.g., 0, represents a higher level of inherent default risk. In preferred embodiments, in other to produce an accurate prediction, modules M1, M2, M3 and M5 are used.

M1, or Firm-o-graphic & public record model, evaluates information such as information listed in Table 36, below.

TABLE 36
Firm-o-graphic & public record model

| X# | Weight | Label | Description |
|---|---|---|---|
| X1 | w1 | Liens | # of Liens |
| X2 | w2 | Suits | # Suits |
| X3 | w3 | Judgments | # Judgments |
| X4 | w4 | Dlines | Dollar value of Liens |
| X5 | w5 | Djudgment | Dollar value of Judgments |
| X6 | w6 | Dsuits | Dollar value of suits |
| X7 | w7 | DefBusSize | Business Size -- Micro, Small, Middle |
| | | | market, large and very large |
| | | | corporations |
| X8 | w8 | History | Business statused N, O, P, Q in the past |
| X9 | w9 | Comp_type | Company type -- G, H, I, J |
| X10 | w10 | Cond_Ind | Business Condition Indicator -- T, U, |
| | | | V, W |
| X11 | w11 | Location | Business Location in -- A to F |
| X12 | w12 | Cottage | Cottage Industry indicator |
| X13 | w13 | Manf | Manufacturing Indicator |
| X14 | w14 | Opresind | Operating from a Residence |
| X15 | w15 | PvtPub | Public or Private company |
| X16 | w16 | Pop_Cd_New | Population Code 1, 2, 3, 4, 5 |
| X17 | w17 | UCC_IND | UCC filing Indicator |
| X18 | w18 | SP_EVENT | Special Event about the |
| | | | company -- fire, criminal and etc |

M1 utilizes information from Table 1 to gauge the level of default risk inherent in a business. To assess the level of risk within M1, “Good” or “Bad” businesses are assigned to a numerical value of 0 and 1, respectively.

It is customary to describe the target or dependent variable as Good or Bad. The Good businesses are businesses that did not default on their obligations and the Bad businesses are businesses that did default on their obligations. This target variable Good/Bad is what is needed to identify the appropriate variables and weights that used to distinguish between Good and Bad accounts in future. The concept of Good/Bad is applied to all models M1-M10.

Next, a logistic regression in Statistical Analysis Software (SAS) is used to identify the best combination of explanatory variables and the appropriate weights. SAS is a logistic regression and is a standard statistical package used by Statisticians, econometricians and quantitative modelers/analysts in the industry. The SAS logistic regression procedure is presented the target (dependent) variable along with the potential list of explanatory variables. The software then searches for the best combination of explanatory variables, and the appropriate weights (parameter or coefficient for each explanatory variable), that produces the best forecast/prediction of the dependent variable. In SAS, the weights associated with each explanatory variable is derived by the method of Iteratively reweighted least squares. The Iteratively reweighted least square is implemented as follows:
Step #1—SAS runs a least square regression between the target variable and the explanatory variables. It then calculates the residuals from this regression. This residuals is further used in calculating a variance-covariance matrix which is then used to weigh all observations in the data
Step #2—SAS proceed by re-running the least squares regression again this time with the variance-covariance weighted variables. The procedure then compares the newly estimated parameters with those estimated in step #1. If there is no significant difference or the difference is within a tolerance limit then no further iteration is required; and the newly estimated parameters then forms the weight that will be given to the respective explanatory variable in the model. If however there is a significant difference between the new parameter estimates and its previous estimate then the process in steps #1 and #2 is repeated. This loop is repeated until the difference between the newly estimated parameter and the previous parameter estimates converge. That is, is within the preset tolerance limit.

After the weight of each attribute is calculated, a sum of the product of the weight (w) and the respective variables (X) is calculated according to log-odds (f(x)) score provided below. The log-odds is (f(x)) score then transformed into a score that ranges from 1 through 100. A larger score correlates to a lower level of inherent risk determined for the business.

$$f ( x ) = {a}_{0} + {\sum }_{n = 1}^{18} ( {w}_{n} {X}_{n} )$$

M2, or Geo-risk model, assesses an immediate geographic environment under which the business operates. M2 establishes an extent to which the location of a business is conducive to conducting a thriving business. M2, evaluates information such as information listed in Table 37, below.

TABLE 37
M2~geo-risk model

| | |
|---|---|
| Moodys | AAA—Moody's Seasoned Aaa Corporate Bond Yield |
| Information: | BAA—Moody's Seasoned Baa Corporate Bond Yield |
| | MoodySpread = BAA-AAA—Spread calculated from |
| | Baa and Aaa Corporate Bond Yields |
| | YoY_MoodySpread = log(Current Month MoodySpread/ |
| | MoodySpread 12 months ago)—Measures % change in |
| | credit risk |
| Treasury: | GS10—10-Year Treasury Constant Maturity Rate |
| | GS3—3-Year Treasury Constant Maturity Rate |
| | TreaSpread = gs10-gs3—The Spread between 10-yr and |
| | 3 yr constant maturity rate |
| UNEMPLOY- | unrate—Civilian Unemployment Rate |
| MENT: | yoy_unrate = log(Current unemployment |
| | rate/unemployment rate 12 months ago)—Year-on-year |
| | Change in unemployment |
| OIL PRICE: | oilprice—Spot Oil Price: West Texas Intermediate |
| | YoY_oilprice = log(Current Oilprice/Oilprice 12 months |
| | ago)—Year-on-year change in oil price |
| Total Business | isratio—Inventory to Sales Ratio: Total Business |
| INVENTORY | YoY_isratio = log(Current inventory to sales ratio/ |
| to Sales ratio: | inventory to sales ratio 12 months ago)—Year-on-year |
| | change in business inventory to sales ratio |
| INDUSTRIAL | indpro—Industrial Production Index |
| PRODUC- | YoY_indpro = log(Current Industrial prod |
| TION: | index/Industrial production Index 12 Months |
| | ago)—Year-on-year change |
| | in industrial production |
| CAPACITY | tcu-Capacity Utilization: Total Industry |
| UTILIZA- | YoY_tcu = log(Current capacity utilization/capacity |
| TION: | utilization 12 mths ago)—Year-on-year change in |
| | capacity utilization |
| PERSONAL | pi—Personal Income |
| INCOME: | YoY_pi = log(Current Personal income/personal income |
| | 12 months ago)—Year-on-year change in personal |
| | income |

In order to assess the an immediate geographic environment under which the business operates, M2 first takes a random samples of 1.5 Million businesses according to a Data Universal Numbering System (DUNS) from a database such as a Dun & Bradstreet database. This sample is taken on a quarterly basis from 1999q4 through 2008Q4.

Next, for each quarter, M2 determines the number of businesses that fall into each State. The selected businesses in each state are then followed for the next 12-months to determine if it was “good” or “bad” at the end of the period.

On this basis, M2 then determines a credit default rate in each state over each of the quarter examined. For example, M2 executes a logistic regression of the “bad” rates in the states against the economic attributes listed above:

$$G ( x ) = {a}_{0} + {g}_{o} * StateDummy + {\sum }_{i = 1} ( {g}_{i} * {Economic\_Attribute}_{i} )$$

The weight (g_{i i=0,1,2 . . .} ) is obtained from the logistic regression, e.g., SAS.

The equation-above describes the evolution of risk in each state over time. Thus to evaluate the riskiness of the environment where a business operates, M2 only requires the place of operation of the business (State Indicator) and the economic indicators as of the time of interest. In addition, the equation-above can be modified to accommodate different weighting schemes for differing sizes of businesses, e.g., a larger business with a footprint in multiple states (or even an international business) may not be as affected as a local business.

Ultimately, M2 transforms the log odds (G(x)) into a score ranging from 1 through 100 (similar to M1). The larger the score the lower the level of inherent risk determined for the business.

M3, or industry risk model, evaluates a state of the industry under which the business operates. Industry risk model 7 establishes the extent to which the industry at large is conducive to conducting a thriving business. Industry risk model 7 provides a methodology similar to that used in M2.

First, M3 takes a random sample of 1.5 Million businesses according to the DUNS from a database such as the Dun and Bradstreet database. This sample is taken on a quarterly basis from 1999q4 through 2008Q4.

Next, M3 determines the number of businesses that fall into an Industry (the 2-digit SIC Code). The selected businesses in each Industry are then followed for the next 12-months to determine if it was “good” or “bad” at the end of the period.

On this basis, M3 then determines the credit default rate in each industry over each of the quarter examined.

Next, M3 executes a logistic regression of the bad rates in the industry against the economic attributes listed above.

Next, M3 evaluates the evolution of risk in each Industry over time according to the equation-below.

$${G}^{′} ( x ) = {{a}^{′}}_{0} + {{g}^{′}}_{o} * IndustryDummy + {\sum }_{i = 1} ( {{g}^{′}}_{i} * {Economic\_Attribute}_{i} )$$

Weights (g′_{i i=0,1,2 . . .} ) are obtained from the logistic regression, e.g., SAS, described above. Thus, to evaluate the “riskiness” of the industry where the business operates, M3 only requires the 2-digit SIC code and the economic indicators as of the time of interest. In addition, the equation provided-above can be modified to accommodate different weighting schemes for differing sizes of businesses, e.g., a larger business that is active in multiple industries may not be as affected as a business active in a single industry.

Ultimately, M3 transforms the log odds (G′(x)) into a range from 1 through 100, whereby the larger the score the lower the level of inherent risk determined for the business.

Module M4, or C_&_O rating, is a financial strength indicator. For example, C_&_O rating 9 can be a Dun and Bradstreet composite credit appraisal score according to Table 38, below.

TABLE 38
M4~Dun and Bradstreet Financial Strength Indicator

| Based on Net Worth | | | | | |
|---|---|---|---|---|---|
| from Interim or Fiscal | | High | Good | Fair | Limited |
| 5A | 50,000,000 | 1 | 2 | 3 | 4 |
| 4A | 10,000,000 | 1 | 2 | 3 | 4 |
| 3A | 1,000,000 | 1 | 2 | 3 | 4 |
| 2A | 750,000 | 1 | 2 | 3 | 4 |
| 1A | 500,000 | 1 | 2 | 3 | 4 |
| BA | 300,000 | 1 | 2 | 3 | 4 |
| BB | 200,000 | 1 | 2 | 3 | 4 |
| CB | 125,000 | 1 | 2 | 3 | 4 |
| CC | 75,000- | 1 | 2 | 3 | 4 |
| DC | 50,00 | 1 | 2 | 3 | 4 |
| DD | 35,00 | 1 | 2 | 3 | 4 |
| EE | 20,00 | 1 | 2 | 3 | 4 |
| FF | 10,00 | 1 | 2 | 3 | 4 |
| GG | 5,000 | 1 | 2 | 3 | 4 |
| HH | 0-4,999 | 1 | 2 | 3 | 4 |

| | |
|---|---|
| DS | DUNS Support - This indicates that the information |
| | available to D&B does not permit us to classify the |
| | company within our Rating Key. When ordering these |
| | reports, an investigation can be performed and results |
| | sent to you at your request for an additional fee |
| INV | Investigation Being Conducted - When an “INV” |
| | appears, it means an investigation is being conducted on |
| | this business to get the most current details. |
| -- | This represents the absence of a D&B Rating and should |
| | not be interpreted as indicating that credit should be |
| | denied. It means that the information available to D&B |
| | does not permit us to classify the company within our |
| | Rating Key and that further inquiry should be made |
| | before reaching a credit decision. Some reasons for |
| | using the “--” symbol include: deficit net worth, |
| | bankruptcy proceedings, lack of sufficient payment |
| | information or incomplete history indicator. |

M4 determines the financial strength indicator by evaluating business according to table 3-above. In particular, the financial strength indicator is a composite credit appraisal whereby:
1 (High) Means very low chance of business failure and will usually pay all obligations within terms
2 (Good) Low chance of business failure and will usually pay most obligations within terms
3 (Fair) Moderate chance of business failure and/or will usually pay most obligations slow
4 (Limited) Higher chance of business failure and/or will usually pay all obligations slow.

M4 evolves over time and determines the default risk of a business using current and previous ratings. That is, M4 quantifies the effect of current and previous rating on future default. M4 involves the use of text and pattern matching combined with logistic regression, e.g., SAS, to determine weights to assign to different text patterns using the same logistic regression for M1, described above.

M4 ultimately determines a score that range from 1 through 100. The larger the score the lower the level of inherent risk determined for the business.

Module M5, or current commercial credit score model, re-aligns a current credit score (CCS) to a recent observed performance.

M5 identifies some businesses of a particular size, in a specific industry, with known “good” or “bad” CCS score and performs a regression calculation on this CCS score. The regression equation is a logistic equation estimated in SAS. using the same logistic regression for M1, described above

M5 is a one factor model where the only factor considered is the current score. The log odds from this regression is also converted to a score that range from 1 through 100 whereby the larger the score the lower the level of inherent default risk determined for the business.

Module M6, or long term payment behavior model, uses performance metrics such as timeliness of payment to creditors, to determine another inherent default risk score. The performance metrics can include a paydex score, i.e., a Dun and Bradstreet paydex score.

M6 analyzes the performance metric, such as a paydex score, according to the average, minimum, maximum, standard deviation and range for the last 3-, 6-, 9-, 12-Months.

M6 further constructs the relative value of current performance metrics to the industry norm or the averages over a certain period to evaluate a trend of payment performance.

M6 determines the distribution of scores, the time series properties of the score (trending and variability) of the score over time. In particular, M6 calculates the inherent default risk score for businesses of certain size, from a particular industry and a certain number of years of operation. M6 performs a logistic regression calculation on the above variables, using the same logistic regression for M1, described above, against businesses that had been identified as “good” or “bad” in the subsequent 12-months.

For example, M6 determines the inherent default risk score according to the following equation:

f(Z)=b₀+Σₙ₌₁⁷(w′ₙZₙ)
Z1: maxpdx_{—}9→Maximum Paydex within the last 9-Months
Z2: minpdx_{—}6→Minimum Paydex within the last 6-Months
Z3: NPAYEXP→Number of Payment experiences
Z4: PAYDEX1→Current Paydex
Z5: PAYNORMComP→Current Paydex Comparison to Industry Paydex Norm
Z6: StdPdx_{—}6→Standard deviation of Paydex within the last 6-Months
Z7 TrendAvg18→Current Paydex Relative to 18-Month Paydex Average

Ultimately, M6 transforms the log odds (f(z)), obtained from the above regression equation, into a score that range from 1 through 100. The larger the score the lower the level of inherent risk determined for the business.

Module M7, or long term trade behavior model, determines another inherent default risk score according to trade data such as a total dollar value of all trade transactions for a business. M7 also accounts for delinquency cycles.

M7 analyzes trade data over 12 to 24 months for a business. That is, for some businesses the trade data is aggregated over the last 12 months and, for the not very active businesses, the trade data is aggregated as far back as 24-months ago. The variables used in M7 are stable and rarely change significantly. Thus, if there is a change in any of the data points then it can be symptomatic of a fundamental change within the.

M7 determines an inherent default risk score for business of a certain size and operating in a specific industry based on a regression of “good” and “bad” identifiers according to the following formula and subsequent attributes:

$$f ( P ) = {b}_{0} + {\sum }_{n = 1}^{5} ( {{w}^{′}}_{n} {P}_{n} )$$

P1: D_{—}90_NM→Balance currently 90-Days Past Due
P2: D_SAT_NM→Balance paid satisfactorily
P3: DPCT90PL_NM→Percent of total dollar 90-DPD or worse past PD
P4: NBR_PDUE_NM→Number of trades past due
P5: PEXP_SAT_NM→Number of payments paid satisfactorily

Ultimately, M7 transforms the log odds (f(P)), obtained from the above regression equation, into a score that range from 1 through 100. The larger the score the lower the level of inherent risk determined for the business.

Module M8, or short and long term financial strength model, determines another inherent default risk score. Short and long term financial strength model is broken into two components; the (i) short term financial strength and the (ii) long term financial strength.

The short term financial strength is determined according to the latest financial statement of the business and evaluates the implications for credit risk. This short term financial strength model uses the short term financial model and typically available for most businesses.

The short term financial strength can be determined by a logistic regression calculation for a set of businesses known to have good or bad short term financial strength against the financial ratios computed from the financial statements. The logistic regression is used to optimally put weight on the significant set of financial accounting ratios. For example,

$$f ( CF ) = {b}_{0} + {\sum }_{n = 1}^{10} ( {{w}^{′}}_{n} {CF}_{n} )$$

CF1→Current working capital turnover ratio
CF2→Current tangible equity

### CF3→Return on Assets

CF4→Receivable turnover
CF5→Long Term Obligations to net working capital

### CF6→Debt to Tangible Equity Ratio

### CF7→Capex to Sales

### CF8→Acid Ratio

### CF9→Times Interest Covered

### CF10→Cash to Total Assets

The weight assigned to respective attributes CF1-CF10 is determined from the logistic regression, e.g., SAS described in M1—above. The log odds (f(CF)), obtained from the above regression equation, is then transformed into a score (S(CF)) that ranges from 1 through 100. The larger the score the lower the level of inherent risk determined for the business.

The long term financial strength is used for a business in operation for a much longer time period, thus having a greater depth of financial data. That is, businesses that are evaluated under the long term financial strength model have at least 3 or more years of financial data a separate evaluation of the long term financial trend and performance is also examined.

For example, the long term financial strength can incorporate financial data such as:

LF1→Standard variance of net income over at the last 3-years
LF2→Average gross margin over the last 3 years
LF3→Range of number of times cash covers total liability over the last 3 years
LF4→Average year-over-year growth in Total Revenue over the last 3 years
LF5→Minimum number of times Interest covered over the last 3 years

This financial data can be regression analyzed according to a set of businesses with known good or bad against the financial ratios determined from 3 or more years of financial statements. The logistic regression is used to optimally put weight on the significant set of accounting ratios, e.g., using SAS from model M1, described above. For example,

$$f ( LF ) = {b}_{0} + {\sum }_{n = 1}^{5} ( {{w}^{′}}_{n} {LF}_{n} )$$

The log odds f(LF) obtained from the above regression equation is then transformed into a score (S(LF)) that ranges from 1 through 100, whereby a larger score correlates to a lower level of inherent risk.

M8 then combines the values from the long term financial strength model and short term financial strength model to yield a composite financial score.

To combine the values, M8 first determines a depth of financial data available. If less than 3 years of financial data is available the composite financial score (BS) is the same as the short term financial score (based on current financial data only). For example, BS=S(CF).

If greater than 3 years of financial data is available, M8 blends the short term financial score and the long term financial score. The blended weight (π) is applied to both scores. This blended weight is also determined from the result of logistic regression on businesses with known good or bad variables and having deep financial data. During model estimation the target (dependent) variable has to be known. The data collected for model estimation was observed in the past.

For example,

BS=π*S(CF)+(1−π)*S(LF)

Wherein, the blended score also range from 1 through 100.

Module M9, or national rating from Moody's, Standard & Poors, Fitch, DBRS, AM Best, determines another inherent default risk score.

M9 is determined from a look up table. Table 39 is provided-below as an example of a look up table used by M9.

TABLE 39
M9~look up table

| | Moody's | | Standard and | |
|---|---|---|---|---|
| Score | Rating | Fitch | Poor's | Best |
| 100 | Aaa | AAA | AAA | A++ |
| 100 | Aa1 | AA+ | AA+ | A+ |
| 100 | Aa2 | AA | AA | A |
| 100 | Aa3 | AA− | AA− | A− |
| 100 | A1 | A+ | A+ | B++ |
| 100 | A2 | A | A | B+ |
| 100 | A3 | A− | A− | B |
| 100 | Baa1 | BBB+ | BBB+ | B− |
| 99 | Baa2 | BBB | BBB | C++ |
| 99 | Baa3 | BBB− | BBB− | C+ |
| 98 | Ba1 | BB+ | BB+ | C |
| 96 | Ba2 | BB | BB | C− |
| 94 | Ba3 | BB− | BB− | D |
| 90 | B1 | B+ | B+ | E |
| 85 | B2 | B | B | F |
| 78 | B3 | B− | B− | S |
| 70 | Caa1 | CCC+ | CCC+ | S |
| 61 | Caa2 | CCC | CCC | S |
| 50 | Caa3 | CCC− | CCC− | S |
| 40 | Ca1 | CC | CC | S |
| 30 | Ca2 | C | R | S |
| 21 | Ca3 | C | R | S |
| 9 | C | C | R | S |

Module M10, or short term trade behavior model based on detail trade data, determines another inherent default risk score similar to M7.

M10 analyzes trade related data aggregated over the last few weeks (within the last 1-month). This data is contained in what is called the Detailed Trade Data. Thus, M10 uses the most recent data and the power of the most recent activity have not been diluted by data observed further in the past.

For example, for business of a certain size and operating in a specific industry the short term risk may be evaluated based on the regression of “good” or “bad” identified analogous to the SAS regression testing used in M1, discussed above. In addition, a weight assigned to respective short term trade, or detailed trade, attributes is determined from the SAS logistic regression. The following formula and set of attributes are also used to evaluate the short term risk:

$$f ( DT ) = {q}_{0} + {\sum }_{n = 1}^{5} ( {{q}^{′}}_{n} {DT}_{n} )$$

DT1: D_{—}90_NM→Detailed Trade Balance currently 90-Days Past
DT2: D_SAT_NM→Detailed Trade Balance paid
DT3: DPCT90PL_NM→Detailed Trade Pent of total dollar 90-DPD or worse past PD
DT4: NBR_PDUE_NM→Detailed Trade Number of trades past due
DT5: PEXP_SAT_NM→Detailed Trade Number of payments paid satisfactorily

M10 then transforms the log odds (f(DT), obtained from the above regression equation, into a score that ranges from 1 through 100. The larger the score the lower the level of inherent risk determined for the business.

The commercial data 1 attributes, e.g., scores ranging from 1-100 from modules M1-M10 are processed to create a commercial risk model score 29, e.g., block B. In particular, for some businesses not all modules M1-M10 will yield data. For example, there are instances that a business may not have data for a particular model. In these instances, when data is not available, a numerical value of 0 is substituted for the model score.

Typically, scores for modules M1, M2, M3 and M5 are available. The reason being that these modules require information that is readily available. In particular, the industry that a business belongs to is known and, thus, the M3, industry risk faced by the business is known. In addition, the place of operation of the business, i.e., M2: Geo-risk module, is known and, thus, quantifying the geo-risk faced by the business is available.

For additional other modules such as M6: Long Term Payment behavior, M7: Long Term Trade behavior, M8: Financial Model, a payment history must be available. For example, to determine M6 and M7, trades reported must be available, to determine M8, financial statements must be submitted. Accordingly, the requisite payment history is not always available to determine M6, M7 and M8 and, thus, a zero score is allocated for modules having insufficient data.

To allocate a zero score, a dummy variable (D_(n)) is created and assigned a numerical value of 1 for this observation and a value of 0 otherwise. The dummy variable is an indicator variable that is used to flag the presence or absence of a particular event. As used here, the dummy variable distinguishes between businesses that have a valid score from a module and those that do not. Businesses that do not have a score are also used in the regression, e.g., SAS regression discussed above. Thus, this effects biasing the weight estimate. The dummy variable accounts for the records used that did not have a score, and further, to impute those scores. In short, the dummy variable corrects for the possible bias that could be introduced by the score imputation.

Next a weight for the modules and dummy variables is determined from running a logistic regression of the module score and associated dummies on good/bad accounts. The good account is an account that did not default on its obligations and the bad account is an account that defaulted on its obligations.

For example, the logistic regression can be determined by the following equation:

$$T ( M ) = {a}_{0} + {\sum }_{n = 1}^{10} ( {a}_{n} {M}_{n} + {b}_{n} {D}_{n} )$$

A score estimated from the above logistic regression equation yields commercial risk model score 29. The Block B: commercial risk model score 29 includes the equation C(M, γ). C(M, γ). is a function of the modules (M) output indexed or weighted by the parameter γ. The exact function used is logistic function. This functional mapping is used to combine the modules to derive a composite score that reflect all the risk evaluation from the various modules.

System 200 then determines if the business being evaluated is a micro-business (MB) or small-business (SMB).

If the business being evaluated is not a MB or SB, system 200 progresses to block F: large corp, middle market & med. size business 31. At this block, commercial risk model score 29 is returned as a new consumer credit score which is transmitted to block H: final core reported to customers 33.

Prior to being received at block H, however, a penalty score 35 may be applied. If the business being evaluated is flagged as a business deterioration (BD), a business uncertainty (BU), a high risk alert (HRA) or information alert (IA), then penalty score 35 is applied. Otherwise, no penalty score 35 is applied.

A BD is a sign of financial distress, including signs of current or imminent business failure or operating difficulty. The BD includes the following factors: numerous and significant liens and/or judgments, natural disasters (floods, hurricanes, fires, etc), lending difficulties or defaults, public announcement of imminent business closure, overall payment records declines significantly, “Going Concern” clause as noted in the company's audited financial statement, and license revocations.

A BU is a sign of financial distress that includes factors such as: banking cease and desist orders, and newsworthy events.

An IA is a sign of financial distress that includes factors such as: debarments, financial covenant violations, de-listings from the stock market, and “Going Concern” clause (subsidiary affiliation)

A HR is another sign of financial distress that displays characteristics of deception or misrepresentation. The HR include factors such as: information that conflicts with public or third-party sources, knowingly omits significant or negative information, misrepresents information to Dun & Bradstreet, it's suppliers and/or it's customers.

For instances that penalty score 35 applies, penalty score 35 can determined as follows:

$$Score = \{ \begin{matrix}Suppress Score if BD \\ T ( M ) - 100 if BU \\ T ( M ) - 25 if HRA \\ T ( M ) - 10 if IA \\ T ( M ) if Otherwise\end{matrix}$$

If the business being evaluated is a MB or SB, system 200 progresses to block D: Project Star 37. At block D, commercial risk model score 29 is blended with consumer attributes 23.

Consumer attributes 23 are broken into two attributes: zip level consumer attribute based on commercial risk score 25 and individual level consumer attribute based on commercial risk score 27.

Zip level consumer attribute based on commercial risk score 25 refers to a summarized aggregate level consumer information at a Zip Code level. Each consumer attributes such as a Bureau score, a number of trades, a percentage of trades delinquent. The consumer bureau calculates an average for each attribute in its database according to each ZIP code in the country. The resultant average value for each attribute is a zip level consumer attribute based on commercial risk score 25.

Individual level consumer attribute based on commercial risk score 27 refers to attributes such as a credit bureau score, a total number of trades, a percentage of trades delinquent, that can be matched to a specific individual from the credit bureau database. The individual level consumer attribute based on commercial risk score 27 is a summary for information within an individual credit bureau file. Thus individual level consume attribute based on commercial risk score 27 includes metrics such as how many trades were open, time since those trades were opened, the number of revolving trades and the number of trades past due.

Consumer attributes 23 are then weighted as follows:

$$CONS = {xw}_{0} + {\sum }_{n = 1}^{10} ( {{xw}^{′}}_{n} {CONS}_{n} )$$

CONS1 Ratio Of New Trades Which Are Bank Revolving Trades
CONS2 Average Utilization Of All Trades
CONS3 Total Retail Debt Per Consumer
CONS4 Number Of Active Retail Trades Per Retail Borrower
CONS5 Proportion Of Tram Scores <=421, Bottom 5% Range Of Scores In The Validation Sample
CONS6 Number Of Active Bank Installment Trades Per Bank Installment Borrower
CONS7 Proportion Of Tram Scores >=595 And <=700, The Second Lowest Quartile Of The Validation Sample
CONS8 Average Amount Past Due On Mortgages Currently 60 Days Or More Past Due
CONS9 Number Of Mortgages Per Mortgage Borrower
CONS10 Ratio Of Bank Installment Borrowers Currently 120 Days Or More Past Due

Consumer attributes 23 are then transformed into a numerical value, similar to each of modules M1-M10, according to a scale from 1-100. The larger the score the lower the level of inherent risk determined for the business. The numerical value is transformed according to the SAS logistic regression discussed in M1—above.

At Block D, Project Star 37 receives the commercial risk model score 29 and the consumer attributes 23 (S(CONS)). to generate a blended commercial default risk score (S(T(M))) as follows:

$${T}^{″} ( M ) = {a}_{0} + {\sum }_{n = 1}^{10} ( aS ( T ( M ) ) + bS ( CONS ) + cD )$$

In the event that one or both of consumer attributes 23 cannot be determined, a numerical value of 0 is assigned and a dummy variable (D) is substituted to take the value of 1. The dummy variable (D) is the same as that discussed for the Modules M1-M10—above.

Block D: project star 37 includes the equation C(DB,TU;β). C(DB,TU;β) is a function of the consumer attributes 23 output indexed or weighted by the parameter β and the commercial risk model score 29. The exact function used is logistic function. This functional mapping is used to combine the consumer attributes 23, e.g., zip level consumer attribute 25 and individual level consumer attribute 27, to derive a composite score that reflect all the risk evaluation from the various modules. The blended commercial default risk score is then transmitted to block G.

At block G, the membership of a DUNS is first identified as MB or SMB. Given the identified size membership, for example: Micro, the scores calculated from Block D, are then sorted in descending order. The top 1% of the businesses have a rank of 100 among all MB. The next top 1% have a rank of 99, until a bottom scoring group if reached. This enables businesses to be allocated a rank for a particular size range. Ultimately, block G returns a micro and small business score 39.

After block G, the blended commercial default risk score is transmitted to block H: final score reported to customers 33. Prior to this, however, a penalty score 35 is applied.

Similar to how penalty score 35 is applied for the new commercial credit score 31 of block F, penalty score 35 is applied to micro and small business score 39 of block G.

That is, if the business is evaluated as the Business Deterioration (BD), the Business Uncertainty (BU), the High Risk Alert or the Information Alert (IA), the penalty score 35 is applied. Penalty score 35 is applied as follows:

$$Score = \{ \begin{matrix}Suppress Score if BD \\ {T}^{″} ( M ) - 100 if BU \\ {T}^{″} ( M ) - 25 if HRA \\ {T}^{″} ( M ) - 10 if IA \\ {T}^{″} ( M ) if Otherwise\end{matrix}$$

After penalty score 35 is applied, micro and small business score 39 is received at block H: final score reported to customers 33.

An example of the processing at the above-discussed blocks in FIG. 2, i.e., modules M1-M9 is provided by Table 40-below.

TABLE 41
Example of Processing in FIG. 2

| | | | | Normal- | | | | Inter- | | | | |
|---|---|---|---|---|---|---|---|---|---|---|---|---|
| | Mod- | | Actual | ized | weight | | | mediate | Score | Weight | Com- | Final |
| | ule | Attribute | Value | Value | 1 | xbeta | Odds | Score | selector | 2 | biner | Score |
| Block | M1 | Firmographic & Public Records | | | | | | | | | | |
| A | | Business Condition | 8.00 | 2.00 | 0.80 | 1.60 | | | | | | |
| | | # Suit Lien and Judgement | 2.00 | 0.02 | −0.40 | −0.01 | | | | | | |
| | | $ Suit Lien and Judgement | 1000000.00 | 0.67 | −0.60 | −0.40 | | | | | | |
| | | | | | | | 3.29 | 76.71 | | | | |
| | | M1-Dummy | | | −5.00 | | | | 76.709857 | 0.1 | 7.67099 | |
| | M2 | Geo-Risk | | | | | | | | | | |
| | | State (In Descending order | 2.00 | 0.08 | −0.60 | −0.05 | | | | | | |
| | | of Risk) | | | | | | | | | | |
| | | Year/Year Change in | 0.02 | 0.20 | −0.30 | −0.06 | | | | | | |
| | | MoodySpread(BBB -- AAA) | | | | | | | | | | |
| | | Year/Year change in Oil Price | 0.02 | 0.20 | −0.40 | −0.08 | | | | | | |
| | | Year/Year Change in | 0.02 | 0.20 | 0.70 | 0.14 | | | | | | |
| | | Personal Income | | | | | | | | | | |
| | | | | | | | 0.95 | 48.80 | | | | |
| | | M2-Dummy | | | −5.00 | | | | 48.80023 | 0.2 | 9.76005 | |
| | M3 | Industry Risk | | | | | | | | | | |
| | | SIC3 Code (In Descending order | 100.00 | 1.00 | −1.80 | −1.80 | | | | | | |
| | | of Risk) | | | | | | | | | | |
| | | Year/Year Change in | 0.12 | 1.20 | −0.30 | −0.36 | | | | | | |
| | | MoodySpread(BBB -- AAA) | | | | | | | | | | |
| | | Year/Year change in Oil Price | 0.06 | 0.60 | −0.54 | −0.32 | | | | | | |
| | | Year/Year Change in | 0.10 | 1.00 | 1.50 | 1.50 | | | | | | |
| | | Personal Income | | | | | | | | | | |
| | | | | | | | 0.37 | 27.21 | | | | |
| | | M3-Dummy | | | −5.00 | | | | 27.209882 | 0.3 | 8.16296 | |
| | | D&B Rating | | | | | | | | | | |
| | M4 | Change in Capital | 1000000.00 | 2.00 | 1.00 | 2.00 | | | | | | |
| | | Base--Networth | | | | | | | | | | |
| | | Previous Composite Credit | 1.00 | 0.25 | −1.20 | −0.30 | | | | | | |
| | | Rating | | | | | | | | | | |
| | | Previous Capital level | 1000000.00 | 0.67 | 2.50 | 1.67 | | | | | | |
| | | | | | | | 28.98 | 96.66 | | | | |
| | | M4-Dummy | | | −5.00 | | | | 96.664639 | 0.3 | 28.9994 | |
| | M5 | CCS Score | | | | | | | | | | |
| | | Previous score | 700.00 | 360.00 | 0.02 | 6.24 | 512.00 | 99.81 | | | | |
| | | M5-Dummy | | | −5.00 | | | | 99.805068 | 0.4 | 39.922 | |
| | | Long Term Payment Behaviour | | | | | | | | | | |
| | | Current Paydex | 90.00 | 0.90 | 2.00 | 1.80 | | | | | | |
| | | Paydex variability over | 10.00 | 2.00 | −3.00 | −6.00 | | | | | | |
| | | 12-months | | | | | | | | | | |
| | M6 | Current Paydex relative to | 1.50 | 1.50 | 2.50 | 3.75 | | | | | | |
| | | Industry Norm | | | | | | | | | | |
| | | | | | | | 0.64 | 38.94 | | | | |
| | | M6-Dummy | | | −5.00 | | | | 38.936077 | 0.5 | 19.468 | |
| | M7 | Long Term Trade Behaviour | | | | | | | | | | |
| | | Balance paid satisfactorily | 10000.00 | 1.00 | 0.50 | 0.50 | | | | | | |
| | | Percent of total dollar 90-DPD | 0.00 | 0.00 | −0.10 | 0.00 | | | | | | |
| | | or worse past PD | | | | | | | | | | |
| | | Number of trades past due | 0.00 | 0.00 | −0.50 | 0.00 | | | | | | |
| | | | | | | | 1.65 | 62.25 | | | | |
| | | M7-Dummy | | | −5.00 | | | | 62.245933 | 0.4 | 24.8984 | |
| | M8 | Short and Long Term Financial | 10000.00 | 1.00 | 0.50 | 0.50 | | | | | | |
| | | Current tangible equity | | | | | | | | | | |
| | | Return on Assets | 0.00 | 0.00 | −0.10 | 0.00 | | | | | | |
| | | Times Interest Covered | 0.00 | 0.00 | −0.50 | 0.00 | | | | | | |
| | | | | | | | 1.65 | 62.25 | | | | |
| | | M8-Dummy | | | −5.00 | | | | 62.245933 | 0.3 | 18.6738 | |
| | M9 | National Financial Ratings | BBB | | | | | 99.00 | | | | |
| | | from NSRO Rating from Moody | | | | | | | | | | |
| | | (S + P, Fitch, or Best) | | | | | | | | | | |
| | | M9-Dummy | | | −5.00 | | | | 99 | 0.1 | 9.9 | |
| | M10 | Short Term Trade Behavior | | | | | | | | | | |
| | | Detailed Trade Number of | 10000.00 | 1.00 | 0.50 | 0.50 | | | | | | |
| | | payments paid satisfactorily | | | | | | | | | | |
| | | Detailed Trade Balance currently | 0.00 | 0.00 | −0.10 | 0.00 | | | | | | |
| | | 90-Days Past Due | | | | | | | | | | |
| | | Detailed Trade Balance paid | 0.00 | 0.00 | −0.50 | 0.00 | | | | | | |
| | | satisfactorily | | | | | | | | | | |
| | | | | | | | 1.65 | 62.25 | | | | |
| | | M10-Dummy | | | −5.00 | | | | 62.245933 | 0.15 | 9.33689 | |
| | FIG. 2, Block B, Commerial Risk Score | | | | | | | | | 0.7 | | 64.29 |
| Block | TU -- | Consumer Information at ZIP | | | | | | | | | | |
| C | ZIP | Level | | | | | | | | | | |
| | | Average Utilization Of | 1.00 | 0.02 | −0.30 | −0.01 | | | | | | |
| | | All Trades | | | | | | | | | | |
| | | Proportion Of Tram | 1.00 | 0.02 | −0.40 | −0.01 | | | | | | |
| | | Scores <= 421 | | | | | | | | | | |
| | | Ratio Of New Trades Which Are | 90.00 | 1.80 | 0.60 | 1.08 | | | | | | |
| | | Bank Revolving Trades | | | | | | | | | | |
| | | | | | | | 2.90 | 74.38 | 74.38 | 0.5 | | |
| | FIG. 2, Block D, Blended Commerial Risk Score | | | | | | | | | | | 68.49 |
| Block | TU -- | | | | | | | | | | | |
| C | INDV | Personalized Consumer | | | | | | | | | | |
| | | Information | | | | | | | | | | |
| | | Total # Trades | 10.00 | 3.33 | 0.50 | 1.67 | | | | | | |
| | | Percent utilization rate | 20.00 | 0.40 | −0.40 | −0.16 | | | | | | |
| | | Months since oldest trade | 60.00 | 1.67 | 0.70 | 1.17 | | | | | | |
| | | | | | | | 14.49 | 93.54 | 93.54 | 0.6 | | |

| | |
|---|---|
| FIG. 2, Block D, Premium Blended Commerial Risk Score | 77.79 |

According to Table 41-above, an “actual value is” refers to the value of an attribute used in scoring as it appears in a database, e.g., a Dun and Bradstreet database. The actual value is raw data used by the scoring algorithm

The normalized value is a transformed value of the original actual attribute. To create the normalized value the actual value is typically scaled by the variance or the range of the attributes. The normalized value thus represents the relative value of the actual value to some reference value

Weight 1 represents the weight parameter associated with the attributes used in the respective modules discussed-above.

Xbeta is the product of the Normalized value and weight for the respective variable in each module

Odds is the exponentiation of the sum of Xbeta for the respective modules. It measures the chance or the likelihood of an event happening

The Intermediate score is the product of 100 and the probability of an event happening. This result is specific to each module M1-M10.

The score selector is used in the second stage regression when combining the results from all the modules. The score selector holds the value of the score from the module if the actual values are non-blank and a valid score is calculated; or the value of the dummy variable which indicate that there are no actual value nor score from the respective module.

Weight 2 represents the weights applied to the result of the modules in other to form a composite opinion on the default risk of the business. For a description of how this weight is determined. Reference the SAS discussion-above.

The combiner is the product of weight 2 and the score selector. It is analogous to the Xbeta in the modules.

The final score represents the score that will be returned from the calculations. The commercial risk score is the sum of the combiner scaled or normalized by the sum of weight2 (64.2). This result is obtained from the modules. The blended commercial risk score with TU Zip level data is a weighted combination of the commercial risk score and the result from the TU Zip Score module (68.4). The premium blended is also a weighted combination of Commercial score and the TU score from individual personalized information (77.8).

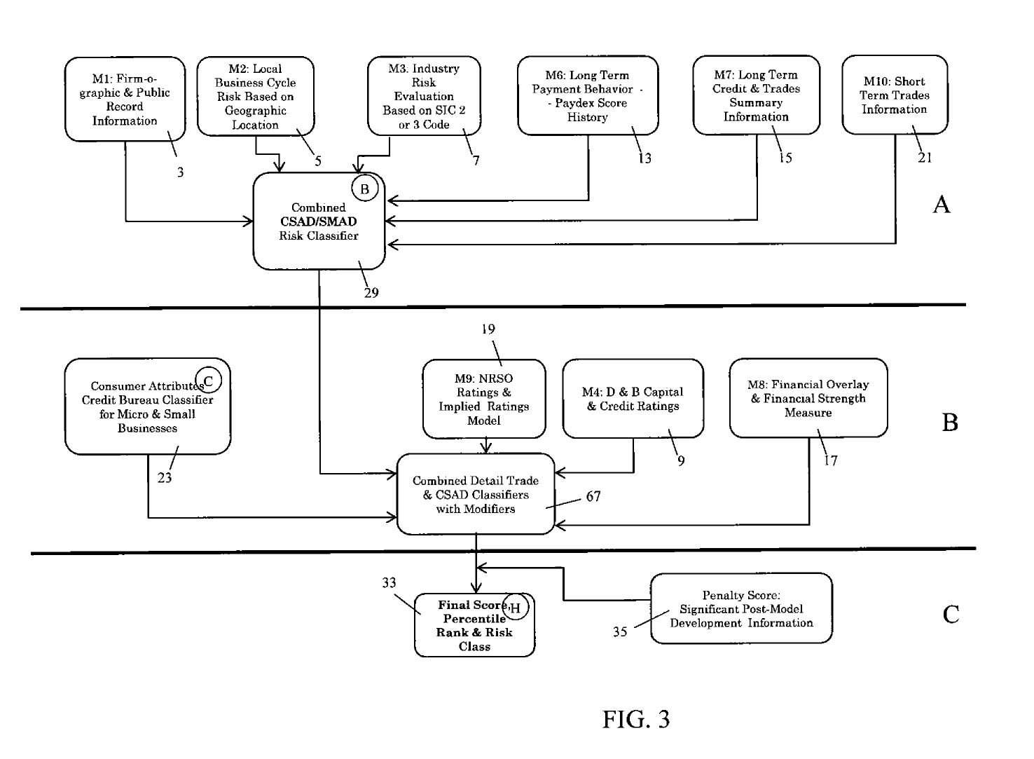

FIGS. 3-8 depict a number of different scenarios that can be accomplished by using the method and system of the present disclosure.

FIG. 3 is a block diagram depicting the general methodology for quantifying and rating default risk of business enterprises according to the present disclosure, wherein at least one category of information selected from the group consisting of: M1: Firm-o-graphic & public record information 3, M2: local business cycle risk based on geographic location 5, M6: industry risk evaluation 7 (based on SIC 2 or 3 code), M6: long term payment behavior, i.e., paydex score history, 13, M7: long term credit and trades summary information 15, and M10: short term trades information 21, are combined via a Block B: CSAD/SMAD risk classifier 29. Thereafter, the CSAD/SMAD risk classifier 29 is then combined with other modifiers, such as Block C: consumer attributes: credit bureau classifier for micro and small business 23, M9: NRSO ratings and implied ratings model 19, M4: capital and credit ratings 9, and M8: financial overlay and financial strength measure 17, to produce the Combined Detail Trade & CSAD Classifiers 67.

Combined Detail Trade CSAD Classifiers, depending on the number of factors present and the size of the business, represents any combination of Block B, F, D or G of FIG. 2. Thereafter, the combined detail trade and CSAD classifiers with modifiers 67 is combined with penalty score: significant post-model development information 35 to produce Block H: a final score, percentile rank and risk class 33.

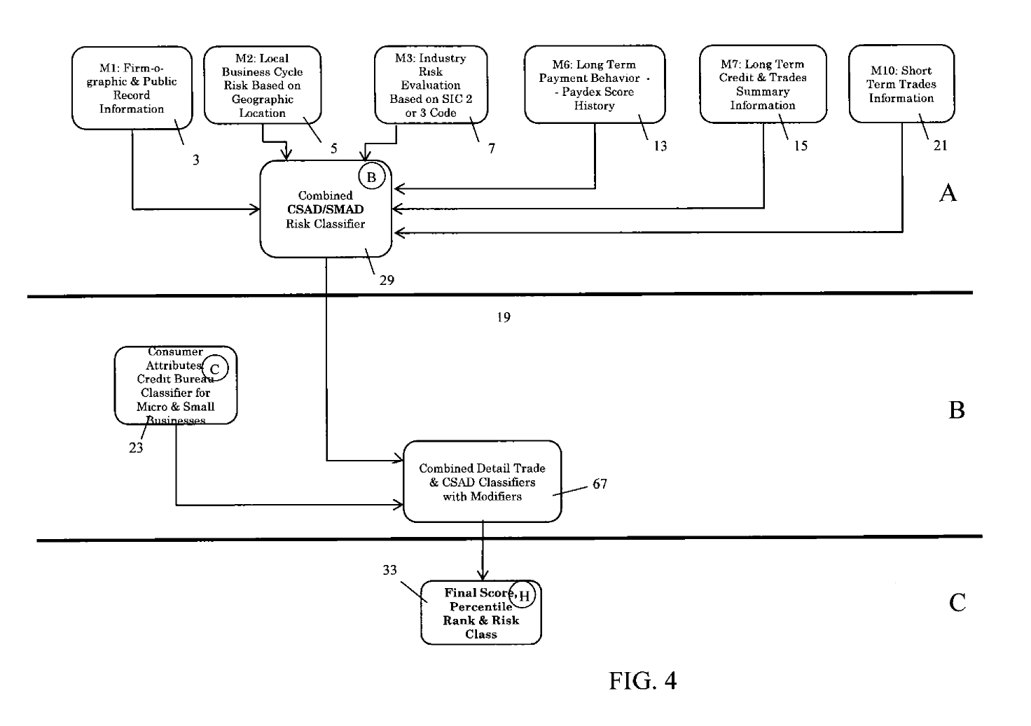

FIG. 4 is a block diagram depicting the methodology when used with micro and small businesses with trades but no significant post model information, which is substantially similar to FIG. 3, above, but wherein only Block C: consumer attributes: credit bureau classifier for micro and small businesses 23 is combined with detail trade and CSAD classifiers 67 to produce a Block H: final score, percentile rank and risk class 33.

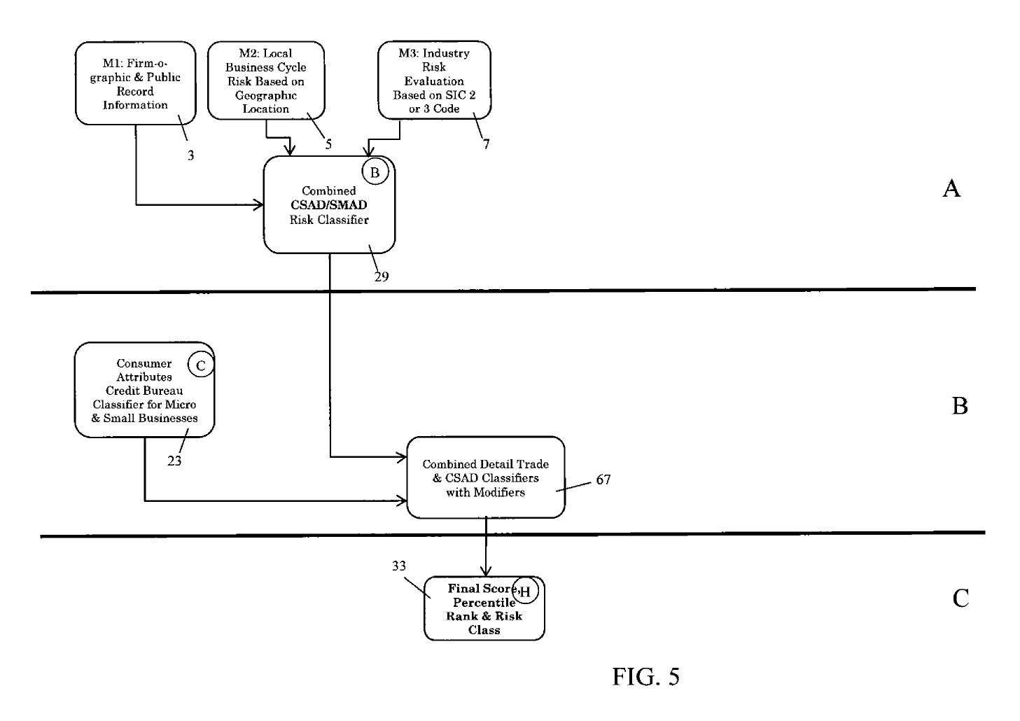

FIG. 5 is a block diagram depicting the methodology when used with micro and small businesses with no trade history and no significant post model development information, which only combines M1: firm-o-graphic and public record information 3, M2: local business cycle risk based on geographic location 5 and M3: industry risk evaluation 7 (based on SIC 2 or 3 code) with Block C: consumer attributes: credit bureau classifier for micro and small businesses 23 in detail trade and CSAD classifiers 67 to produce Block H: final score, percentile rank and risk class 33.

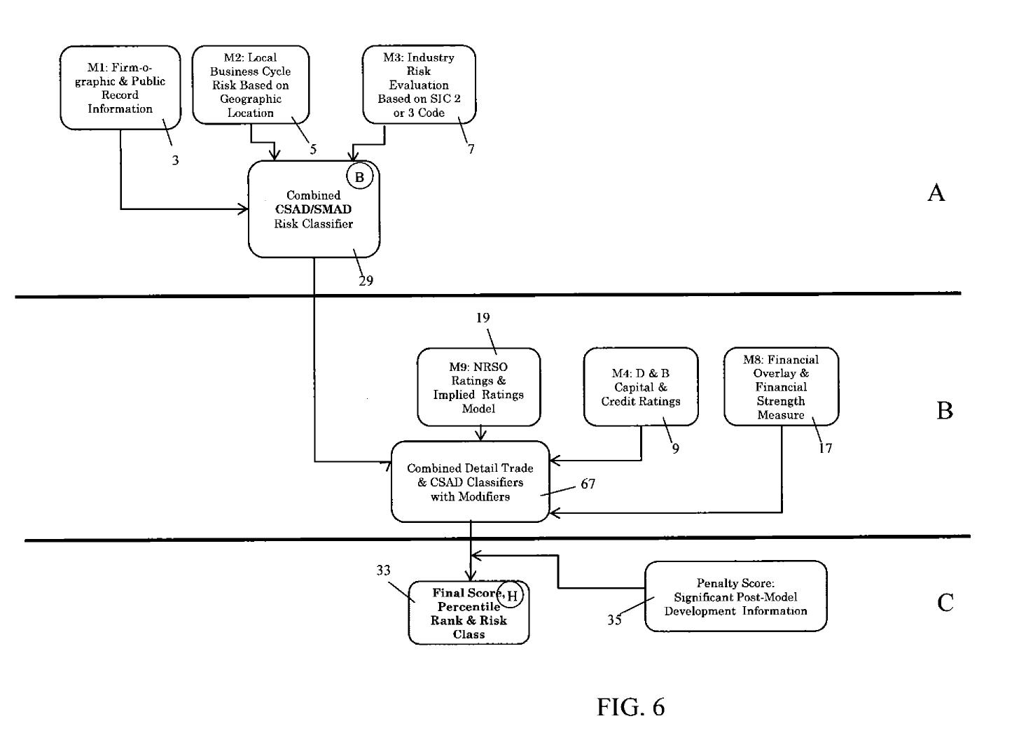

FIG. 6 is a block diagram depicting the methodology when used with large businesses with NRSO rating, D&B rating, financial statements and significant post model development information and no trade history which only combines M1: firm-o-graphic and public record information 3, M2: local business cycle risk based on geographic location 5 and M3: industry risk evaluation 7 (based on SIC 2 or 3 code) with M9: NRSO rating and implied ratings model 19, M4: capital and credit ratings 9 and M8: financial overlay and financial strength measure 17 in detail trade and CSAD classifiers 67. Thereafter, the combined detail trade and CSAD classifier with modifiers 67 is combined with penalty score: significant post-model development information 35 to produce block H: final score, percentile rank and risk class 33.

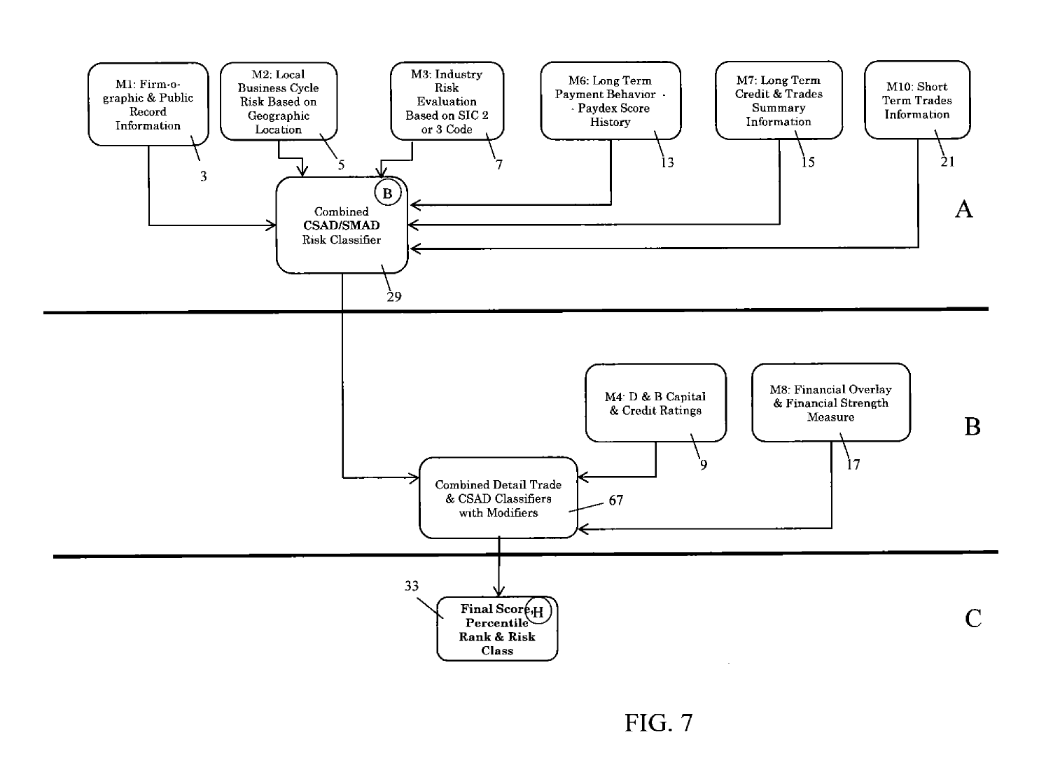

FIG. 7 is a block diagram depicting the methodology when used with large businesses with D&B trades, D&B rating, financial statements and no significant post model development information and No NRSO; wherein at least one category of information selected from the group consisting of: M1: Firm-o-graphic & public record information 3, M2: local business cycle risk based on geographic location 5, M3: industry risk evaluation 7 (based on SIC 2 or 3 code), M6: long term payment behavior, i.e., paydex score history, 13, M7: long term credit and trades summary information 15, and M10: short term trades information 21, are combined via a CSAD/SMAD risk classifier 29. Thereafter, the combined detail trade/CSAD and SMAD classifier 29 are then combined in 67 with other modifiers, such as M4: capital and credit ratings 9, and M8: financial overlay and financial strength measure 17. Thereafter, the combined detail trade and CSAD classifier with modifiers 67 is used to produce Block H: final score, percentile rank and risk class 33.

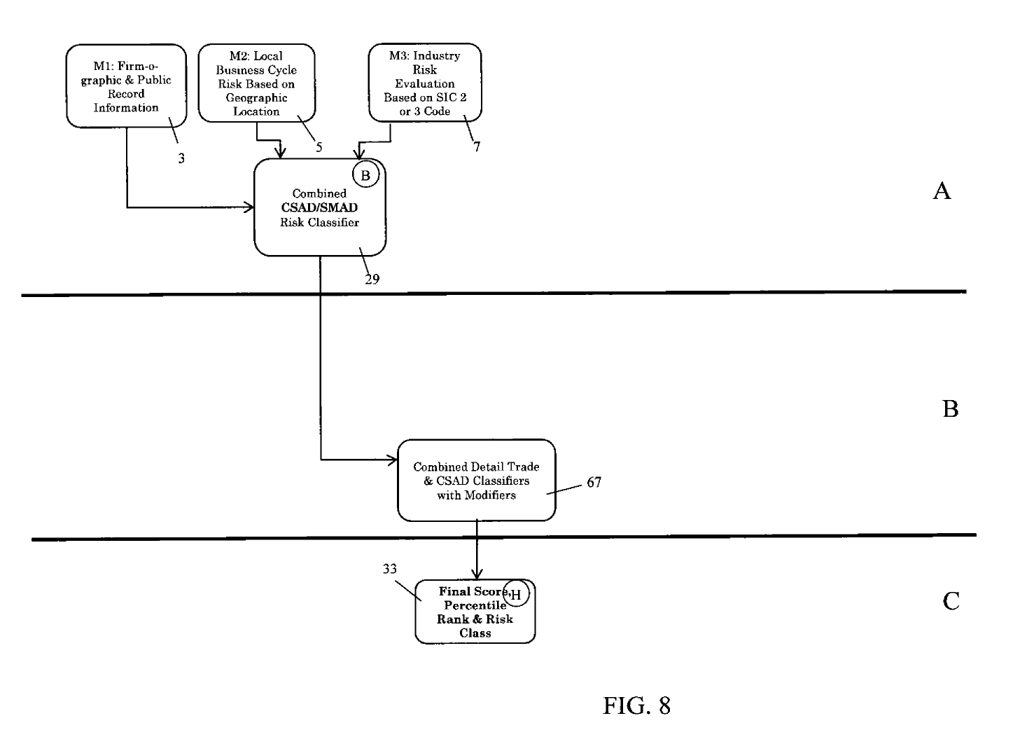

FIG. 8 is a block diagram depicting the methodology when used with large businesses with no NRSO rating, D&B rating, financial statements and significant post model development information; wherein only M1: firm-o-graphic and public record information 3, M2: local business cycle risk based on geographic location 5 and M3: industry risk evaluation (based on SIC 2 or 3 code) 7 are combined in CSAD/SMAD risk classifier 29. Such combined CSAD/SMAD risk classifier information 29 is then combined with detail trade and CSAD classifiers with modifiers 67 to produce Block H: final score, percentile rank and risk class 33.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for evaluating a risk of default for a business comprising:
categorizing commercial data into a plurality of commercial attributes;
allocating each of said commercial attributes to at least one of a plurality of commercial modules;
ranking each of said commercial attributes according to best-attributes for each one of said plurality of commercial modules;
applying a logistic regression model to said best-attributes to yield a commercial score for each one of said plurality of commercial modules; and
determining a commercial risk of default model score by combining all of said commercial scores for said plurality of commercial modules.

2. The method of claim 1, further comprising:
determining a penalty score according to at least one penalty group selected from the groups consisting of: a business deterioration, a business uncertainty, a high risk alert, and an information alert; and
applying said penalty score to said commercial risk of default model score, yielding a final risk of default score.

3. The method of claim 1, further comprising:
categorizing consumer data into a plurality of consumer attributes;
applying a logistic regression model to said consumer attributes to yield a consumer attribute score; and
blending said consumer attribute score with said commercial risk of default model score to yield a blended risk of default score.

4. The method of claim 1, further comprising:
determining a penalty score according to at least one penalty group selected from the groups consisting of a business deterioration, a business uncertainty, a high risk alert, and an information alert; and
applying said penalty score to said blended risk of default score, yielding a final risk of default score.

5. The method of claim 1, wherein said plurality of commercial modules are selected from the groups consisting of: composite credit appraisal score data, long term payment behavior data, long term trade behavior data, short term financial strength data, long term financial strength data, a national rating data, short term trade behavior based on detailed trade data, firm-o-graphic and public record data, geo-risk data, industry risk data, and a current commercial credit score data.

6. The method of claim 1, wherein, when data is not available for one of said plurality of commercial attributes, said ranking further comprises, ranking each of said commercial attributes according to said best-attributes for each one of said plurality of commercial modules having available data.

7. A non-transitory storage medium comprising instructions that are readable by a processor and cause said processor to:
categorize commercial data into a plurality of commercial attributes;
allocate each of said commercial attributes to at least one of a plurality of commercial modules;
rank each of said commercial attributes according to best-attributes for each one of said plurality of commercial modules;
apply a logistic regression model to said best-attributes to yield a commercial score for each one of said plurality of commercial modules; and
determine a commercial risk of default model score by combining all of said commercial scores for said plurality of commercial modules.

8. The non-transitory storage medium of claim 7, wherein said instructions further cause said processor to:
determine a penalty score according to at least one penalty group selected from the groups consisting of: a business deterioration, a business uncertainty, a high risk alert, and an information alert; and
apply said penalty score to said commercial risk model score, yielding a final default score.
categorize consumer data into a plurality of consumer attributes;
apply a logistic regression model to said consumer attributes to yield a consumer attribute score; and
blend said consumer attribute score with said commercial risk of default model score to yield a blended risk of default model score.

9. The non-transitory storage medium of claim 7, wherein said commercial data further comprises at least one selected from the group consisting of: composite credit appraisal score data, long term payment behavior data, long term trade behavior data, short term financial strength data, long term financial strength data, a national rating data, short term trade behavior based on detailed trade data, firm-o-graphic and public record data, geo-risk data, industry risk data, and a current commercial credit score data.

10. A system comprising:
a processor; and
a memory that contains instructions that are readable by said processor and cause said processor to:
categorize commercial data into a plurality of commercial attributes;
allocate each of said commercial attributes to at least one of a plurality of commercial modules;
rank each of said commercial attributes according to best-attributes for each one of said plurality of commercial modules;
apply a logistic regression model to said best-attributes to yield a commercial score for each one of said plurality of commercial modules; and
determine a commercial risk of default model score by combining all of said commercial scores for said plurality of commercial modules.
